(19) United States
(12) Patent Application Publication
(10) Pub. No.: US 2024/0235197 A1
(43) Pub. Date: Jul. 11, 2024

(54) METER-TO-TRANSFORMER CONNECTIVITY

(71) Applicant: Utilidata, Inc., Providence, RI (US)

(72) Inventors: Taylor Spalt, Richmond, VA (US); Zebediah Engberg, Mt. Pleasant, UT (US); Daria Pankova, State College, PA (US); Chris Antonio, Honolulu, HI (US); Brandon Thayer, Spokane, WA (US); Karen Studarus, Seattle, WA (US)

(73) Assignee: Utilidata, Inc., Providence, RI (US)

(21) Appl. No.: 18/532,029

(22) Filed: Dec. 7, 2023

Related U.S. Application Data
(60) Provisional application No. 63/438,283, filed on Jan. 11, 2023.
(60) Provisional application No. 63/453,246, filed on Mar. 20, 2023.

(51) Int. Cl. H02J 3/14; H02J 3/06; H02J 13/00

(52) U.S. Cl. CPC H02J 3/144; H02J 3/06; H02J 13/00022

(57) ABSTRACT

Systems and methods for meter-to-transformer connectivity. The system can include a data processing system comprising one or more processors coupled with memory. The data processing system can receive a time-series data set of voltage measured by meters at a plurality of loads in an electricity distribution grid. The data processing system can construct, based on the time-series data set, a matrix with values that indicate similarities between pairs of meters of the meters. The data processing system can generate, via clustering techniques applied to the matrix, a silhouette score for each of the meters in the matrix to group the meters into transformer groups. The data processing system can provide, for output via a graphical user interface, a digital map with an indication of a subset of meters of the meters associated with a transformer of the transformer groups generated based on the clustering techniques applied to the matrix.

### CROSS-REFERENCES TO RELATED APPLICATIONS

This application claims the benefit of priority under 35 U.S.C. § 119 to U.S. Provisional Patent Application No. 63/438,283, filed Jan. 11, 2023, and U.S. Provisional Patent Application No. 63/453,246, filed Mar. 20, 2023, each of which is hereby incorporated by reference herein in its entirety.

### FIELD OF THE DISCLOSURE

This disclosure relates generally to systems and methods for meter-to-transformer connectivity.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

The utility distribution grids can use meters to observe or measure utility delivery or consumption in the grid. These meters, among other components within utility distribution grids, can collect samples of power delivery or consumption, such as voltage information, at a sample rate (e.g., one sample every 15 to 60 minutes). Within the utility distribution grid, the grouping of loads connected to the same secondary voltage transformer (e.g., referred to herein as a secondary transformer) can be essential in the connectivity relationship at the grid edge (e.g., edge device or electric consumption entities). Secondary transformers can be connected to primary voltage lines connecting to one or more substations (e.g., the delineator between the transmission and distribution grid). Various electrical equipment or components of the utility distribution grid can be located between the secondary transformers and the substations (e.g., switches, capacitor banks, or primary voltage transformers). The set of relationships can map the electrical connectivity of an electrical distribution circuit.

In certain systems, some utilities (e.g., devices or components of the utility distribution grid) can maintain records or information on the load-to-secondary-transformer connectivity within the distribution system, for instance, by utility operators/personnel manually recording the relationships or sending the records to the utilities. However, because connections between the load to the secondary transformer change over time and the records are revalidated relatively infrequently (or not revalidated) after the initial mapping, these systems may be prone to errors with outdated records of the mapping relationship of connectivity at the grid edge. With the increasing adoption of distributed energy resources (DERs) (e.g., photovoltaics (PV), energy storage systems (ESS), electric vehicles (EVs), etc.), electrification of heating or transportation, and to improve the responsiveness or resiliency of electricity delivery, accurate information on the utility distribution system topology (e.g., mapping relationship) can be desirable.

Therefore, the systems and methods of the technical solution discussed herein can include metering devices that can facilitate generating accurate meter-to-secondary-transformer mappings to establish a topology of a utility distribution system. The metering devices can be advanced metering infrastructure (AMI) meters. The metering devices can be positioned or installed at or relatively approximate to the loads. Using the metering devices, the estimation of the load-to-secondary-transformer connectivity can be achieved via data processing techniques discussed herein. Although a certain implementation can be discussed for the systems and methods herein, other strategies for estimating load-to-secondary-transformer can be considered, and are not limited to a single implementation. In some cases, light detection and ranging (LiDAR) or high-resolution images for connectivity estimation can be used. For example, the LiDAR or image datasets can be obtained via satellite, from the road, or overhead using an aerial vehicle or machine (e.g., drone, plane, or helicopter).

This disclosure is directed to a system for meter-to-transformer connectivity. The system can include a data processing system comprising one or more processors, coupled with memory. The data processing system can receive a time-series data set of voltage measured by a plurality of meters at a plurality of loads in an electricity distribution grid. The data processing system can construct, based on the time-series data set, a matrix with values that indicate similarities between pairs of meters of the plurality of meters. The data processing system can generate, via a plurality of clustering techniques applied to the matrix, a silhouette score for each of the plurality of meters in the matrix to group the plurality of meters into a plurality of transformer groups. The data processing system can provide, for output via a graphical user interface, a digital map with an indication of a subset of meters of the plurality of meters associated with a transformer of the plurality of transformer groups generated based on the plurality of clustering techniques applied to the matrix.

The time-series data set can comprise a second matrix having a first dimension corresponding to timestamps and a second dimension corresponding to root mean square voltage values recorded by the plurality of meters at a fixed sampling interval. The data processing system can generate the matrix with values that indicate the similarities using a correlation metric.

The matrix can comprise a covariance matrix. The data processing system can generate the matrix with a Monte Carlo of combinations of at least two of: a plurality of window sizes, filters, similarity metrics, or aggregation techniques to combine correlations between the plurality of meters. The data processing system can generate the silhouette score for each meter via the plurality of clustering techniques with a Monte Carlo of a plurality of initial configurations of meters of the plurality of meters.

The data processing system can execute a Monte Carlo of combinations of parameters used to generate the matrix and initial configurations used to generate the silhouette score. The data processing system can determine a confidence score for a meter of the plurality of meters placed in a transformer group of the plurality of transformer groups based on a count of the combinations of the Monte Carlo of combinations that place the meter into the transformer group.

The data processing system can apply a distance-based clustering techniques of the plurality of clustering techniques to partition the plurality of meters to generate a plurality of partitions of the plurality of meters. The data processing system can generate, via the plurality of clustering techniques applied to each of the plurality of partitions, the silhouette score for each of the plurality of meters.

The data processing system can detect that a meter is erroneously grouped into a first transformer group of the plurality of transformer groups based on a comparison of a first silhouette score of the meter and a first median silhouette score of the first transformer group. The data processing system can remove the meter from the first transformer group and insert the meter into a second transformer group of the plurality of transformer groups. The data processing system can determine a second silhouette score of the meter inserted into the second transformer group is greater than the first silhouette score.

The plurality of clustering techniques can comprise at least one of a distance-based partition, a max rand index, a maximum entropy, or a recursive binary optimization applied to the matrix. The data processing system can adjust a first one or more parameters used to create the matrix to determine an updated matrix. The data processing system can adjust a second one or more parameters of at least one of the plurality of clustering techniques to determine, based on the updated matrix, an updated silhouette score for one or more of the plurality of meters in the matrix to generate an updated subset of meters of the plurality of meters that are associated with the transformer.

The data processing system can receive an indication of an event associated with a transformer of the plurality of transformer groups. The data processing system can identify, via a lookup, a second plurality of meters grouped in a transformer group of the plurality of transformer groups that correspond to the transformer associated with the event. The data processing system can perform, responsive to the event, an action on the second plurality of meters, the action comprising at least one of disabling the plurality of meters, restarting the plurality of meters, or updating an application executed by the plurality of meters.

In another aspect, this disclosure is directed to a method for meter-to-transformer connectivity. The method can include receiving, by a data processing system comprising one or more processors coupled with memory, a time-series data set of voltage measured by a plurality of meters at a plurality of loads in an electricity distribution grid. The method can include constructing, by the data processing system, based on the time-series data set, a matrix with values that indicate similarities between pairs of meters of the plurality of meters. The method can include generating, by the data processing system, via a plurality of clustering techniques applied to the matrix, a silhouette score for each of the plurality of meters in the matrix to group the plurality of meters into a plurality of transformer groups. The method can include providing, by the data processing system for output via a graphical user interface, a digital map with an indication of a subset of meters of the plurality of meters associated with a transformer of the plurality of transformer groups generated based on the plurality of clustering techniques applied to the matrix.

The time-series data set can comprise a second matrix having a first dimension corresponding to timestamps and a second dimension corresponding to root mean square voltage values recorded by the plurality of meters at a fixed sampling interval. The method can include generating, by the data processing system, the matrix with values that indicate the similarities using a correlation metric.

The method can include executing, by the data processing system, a Monte Carlo of combinations of parameters used to generate the matrix and initial configurations used to generate the silhouette score. The method can include determining, by the data processing system, a confidence score for a meter of the plurality of meters placed in a transformer group of the plurality of transformer groups based on a count of the combinations of the Monte Carlo of combinations that place the meter into the transformer group.

The method can include applying, by the data processing system, a distance-based clustering techniques of the plurality of clustering techniques to partition the plurality of meters to generate a plurality of partitions of the plurality of meters. The method can include generating, by the data processing system, via the plurality of clustering techniques applied to each of the plurality of partitions, the silhouette score for each of the plurality of meters.

The method can include detecting, by the data processing system, that a meter is erroneously grouped into a first transformer group of the plurality of transformer groups based on a comparison of a first silhouette score of the meter and a first median silhouette score of the first transformer group. The method can include removing, by the data processing system, the meter from the first transformer group and insert the meter into a second transformer group of the plurality of transformer groups. The method can include determining, by the data processing system, a second silhouette score of the meter inserted into the second transformer group is greater than the first silhouette score. The plurality of clustering techniques can comprise at least one of a max rand index, a maximum entropy, or a recursive binary optimization.

In yet another aspect, this disclosure is directed to a non-transitory computer-readable medium for meter-to-transformer connectivity. The non-transitory computer-readable medium can store processor-executable instructions that, when executed by one or more processors, cause the one or more processors to: receive a time-series data set of voltage measured by a plurality of meters at a plurality of loads in an electricity distribution grid; construct, based on the time-series data set, a matrix with values that indicate similarities between pairs of meters of the plurality of meters; generate, via a plurality of clustering techniques applied to the matrix, a silhouette score for each of the plurality of meters in the matrix to group the plurality of meters into a plurality of transformer groups; and provide, for output via a graphical user interface, a digital map with an indication of a subset of meters of the plurality of meters associated with a transformer of the plurality of transformer groups generated based on the plurality of clustering techniques applied to the matrix.

The instructions can comprise instructions to: execute a Monte Carlo of combinations of parameters used to generate the matrix and initial configurations used to generate the silhouette score; and determine a confidence score for a meter of the plurality of meters placed in a transformer group of the plurality of transformer groups based on a count of the combinations of the Monte Carlo of combinations that place the meter into the transformer group.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 is a block diagram illustrating an example system for meter-to-transformer connectivity, in accordance with an implementation;

FIG. 3 illustrates an example map for estimated meter grouping, in accordance with an implementation;

FIG. 4 illustrates another example map for estimated meter grouping, in accordance with an implementation;

FIG. 5 is a table of an example tabular output of meter grouping results, in accordance with an implementation;

FIG. 6 is a flow diagram of an example method for meter-to-transformer connectivity, in accordance with an implementation;

FIG. 7 is a flow diagram of another example method for meter-to-transformer connectivity, in accordance with an implementation; and

FIG. 8 is a block diagram illustrating an architecture for a computer system that can be employed to implement elements of the systems and methods described and illustrated herein, including, for example, aspects of the utility grid depicted in FIG. 1.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of meter-to-transformer connectivity. The various concepts introduced above and discussed in greater detail below may be implemented in any of numerous ways.

The systems and methods of the technical solution discussed herein can include metering devices positioned or installed at or relatively approximate to the loads. Using these metering devices, the estimation of the load-to-secondary-transformer connectivity can be achieved via data processing techniques discussed herein. The systems and methods can determine the grouping of metering devices associated with at least one respective secondary transformer.

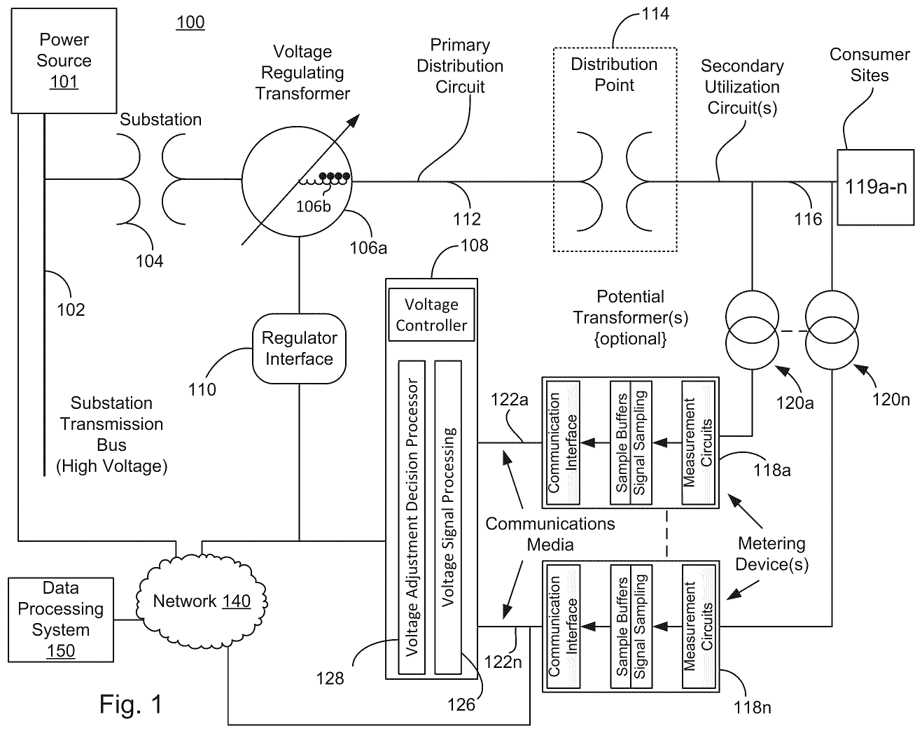

FIG. 1 depicts an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 and/or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 119 connected to circuit 112 or 116 from a power source 101 coupled to bus 102. These metering devices 118a-118n, among other components within utility distribution grids, can collect samples of power delivery or consumption, such as voltage information, at a predetermined sample rate. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

In FIG. 1, in further detail, the utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power plant 101 and the consumer electoral devices 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an alternating current (AC) power distribution system and the term voltage can refer to an “RMS Voltage”, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (“AMI”). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition/event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 140 can be any type and/or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 800 or a portion of computing device 800 or some or all functionality of computing device 800.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuitry (e.g., a central processing unit or CPU) that responses to and processes instructions fetched from a memory unit (e.g., memory 815 or storage device 825). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150.

The data processing system 150 can obtain measurements (e.g., raw or processed data or electric waveforms) from the one or more metering devices 118 within the utility grid 100. The data processing system 150 can receive or obtain the measurements from the metering devices 118 in response to each metering device 118 performing the measurement. The data processing system 150 may receive an aggregate of the measurements from the metering devices 118. In this case, each metering device 118 may store the measurements in a local memory and send the data in response to at least one of a predetermined time interval for a scheduled transmission, receiving a request for data from the data processing system 150, or a predetermined duration, size, or amount of data samples is collected. In some cases, the metering devices 118 can process the data prior to transmitting the data to the data processing system 150.

For automated meter-to-transformer connectivity, the systems and methods of the technical solution can perform features or operations discussed herein for estimating the one or more loads (e.g., metering devices 118) associated with the same secondary transformer (e.g., the grouping of metering devices 118 to a certain secondary transformer). The features can be performed by the data processing system 150 or the metering device 118. In some cases, the data processing system 150 can be remote from the metering device 118. In some other cases, the data processing system 150 may be located locally or connected to the metering device 118. For simplicity and for purposes of providing examples, the data processing system 150 can perform the features or operations, although the metering device 118 can be configured with hardware, software, or a combination of hardware and software capable of performing similar operations.

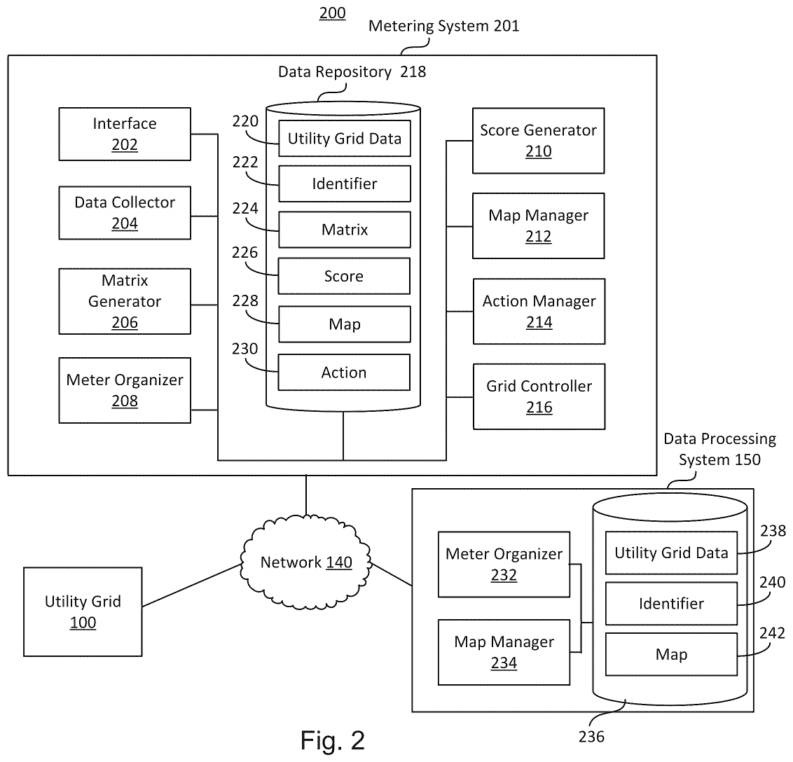

For example, the data processing system 150 can execute a function, utilizing digitized historical input data (e.g., voltage root-mean-square (RMS) data or other types of data) time series recorded by the metering devices 118 as inputs to the function. The data processing system 150 can perform an analysis on the various metering devices 118 within a service area to estimate whether certain loads are connected to the same secondary transformer. The function for determining or estimating connectivity between loads and the secondary transformer (e.g., grouping metering devices 118 to a respective secondary transformer) can involve various stages, for example, indicated as a dataset stage, preprocessing and data munging stage, subdivide stage, meter-to-meter dependence matrix generation stage, and clustering stage. In some cases, there may be more or fewer stages implemented for estimating the load-to-secondary-transformer connectivity. In some configurations, the data processing system 150 or the metering device 118 may correspond to or be a part of a metering system 201. For example, the metering system 201 can include hardware, software, or a combination of hardware and software components of the data processing system 150 or the metering device 118 for grouping the metering devices 118 to a respective secondary transformer (e.g., sometimes referred to generally as a transformer group). The components of the metering system 201 configured for meter-to-transformer connectivity can be described in conjunction with but not limited to at least FIG. 2.

FIG. 2 depicts a block diagram illustrating an example system 200 for meter-to-transformer connectivity. The system 200 can include, interface with, access, or otherwise communicate with at least one utility grid 100, at least one data processing system 150, and at least one metering system 201. The metering system 201 can include one or more components (e.g., one or more processors, memory, databases, or interfaces) configured to perform features or functionalities discussed herein for detecting or determining connectivity between the meter and the transformer (e.g., secondary transformer), managing the grouping of meters (e.g., metering devices 118) under at least one transformer group, or managing the utility grid 100. The metering system 201 can include or correspond to one or more metering devices 118 located in the utility grid 100. In some cases, the metering system 201 can be a computing device local to or remote from the utility grid 100 or the data processing system 150. In some other cases, the metering system 201 can be a part of or perform one or more functionalities similar to the data processing system 150. The metering system 201 can transmit or receive data to or from other components (e.g., utility grid 100 or data processing system 150) of the system 200 via the network 140. The utility grid 100 and the network 140 can be referred to in conjunction with FIG. 1. The one or more devices, components, or systems (e.g., data processing system 150, metering system 201 (or metering devices 118)) of the utility grid 100 or the system 200 can be composed of hardware, software, or a combination of hardware and software components.

The metering system 201 can include or correspond to at least one metering device 118, such as one of the metering devices 118 configured to perform one or more features (e.g., collect and process electricity characteristics) for grouping metering devices 118 in at least one transformer group. In some cases, the metering system 201 can include or correspond to a data processing system 150 configured to perform the one or more features for grouping the metering devices 118. The metering system 201 can be located within the utility grid 100. For example, the metering system 201 can be positioned, installed, or provided at a location downstream from the substation 104 on the utility grid 100 that distributes electricity. Other metering systems can be distributed or installed throughout the utility grid 100, configured to perform one or more features or functionalities similar to the metering system 201. In various cases, the metering systems (including the metering system 201) can correspond to or include edge devices within the utility grid 100.

The metering system 201 can receive and process data locally on the utility grid 100. In some arrangements, the metering system 201 can receive and process data remotely from the utility grid 100. In some cases, the metering system 201 can forward or delegate one or more features or functionalities to another computing device local to or remote from the utility grid 100. For instance, the metering system 201 can transmit data to the data processing system 150 executing in a cloud computing environment or distributed computing environment. In this case, the metering system 201 may perform a portion of the functionalities for processing information (e.g., electrical characteristics) local to the utility grid 100 and the data processing system 150 may perform another portion of the functionalities for processing the information (or processed data from the metering system 201). For purposes of providing an example, the metering system 201 may be a remote computing device or a cloud computing device configured to process data for managing transformer groups.

The metering system 201 can include one or more components for grouping metering devices 118 within the utility grid 100 (e.g., electricity distribution grid) in transformer groups, for instance, at least one interface 202, at least one data collector 204, at least one matrix generator 206, at least one meter organizer 208, at least one score generator 210, at least one map manager 212, at least one action manager 214, at least one grid controller 216, and at least one data repository 218. Each of the components (e.g., interface 202, data collector 204, matrix generator 206, meter organizer 208, score generator 210, map manager 212, action manager 214, grid controller 216, or data repository 218) of the metering system 201 can be implemented using hardware or a combination of software and hardware. Each component of the metering system 201 can include logical circuitry (e.g., a central processing unit or CPU) that responds to and processes instructions fetched from a memory unit (e.g., memory 815 or storage device 825). Each component of the metering system 201 can include or use a microprocessor or a multi-core processor. A multi-core processor can include two or more processing units on a single computing component. Each component of the metering system 201 can be based on any of these processors, or any other processor capable of operating as described herein. Each processor can utilize instruction level parallelism, thread level parallelism, different levels of cache, etc. For example, the metering system 201 can include at least one logic device such as a computing device or server having at least one processor to communicate via the network 140.

The components and elements (e.g., interface 202, data collector 204, matrix generator 206, meter organizer 208, score generator 210, map manager 212, action manager 214, grid controller 216, or data repository 218) of the metering system 201 can be separate components, a single component, or part of the metering system 201. For example, individual components or elements of the metering system 201 can operate concurrently to perform at least one feature or function discussed herein. In another example, components of the metering system 201 can execute individual instructions or tasks. In yet another example, the components of the metering system 201 can be a single component to perform one or more features or functions discussed herein. The components of the metering system 201 can be connected or communicatively coupled to one another, such as via the interface 202. The connection between the various components of the metering system 201 can be wired or wireless, or any combination thereof. Counterpart systems or components can be hosted on other computing devices.

The interface 202 can interface with the network 140, devices within the system 200 (e.g., metering device 118, data processing system 150, or utility grid 100), or components of the metering system 201. The interface 202 can include features and functionalities similar to the communication interface of one or more metering devices 118 or the data processing system 150 to interface with the aforementioned components, such as in conjunction with FIG. 1. For example, the interface 202 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 202 can include at least a built-in network adapter, network interface card, PCMCIA network card, EXPRESSCARD network card, card bus network adapter, wireless network adapter, USB network adapter, modem, or any other device suitable for interfacing one or more devices within the system 200 to any type of network capable of communication. The interface 202 can communicate with one or more aforementioned components to receive data from at least one of the utility grid 100, the metering device 118, or the data processing system 150, such as data representative of electricity distribution to or consumed by individual metering devices 118 within the utility grid 100 or instructions from the data processing system 150.

The data collector 204 can obtain or collect electrical data within the utility grid 100. The electrical data can include data samples of an electrical waveform corresponding to electricity (e.g., electrical signals) distributed at or to one or more locations associated with individual metering devices 118 on the utility grid 100. For example, the data collector 204 can collect electrical data in residential areas (e.g., residential homes), such as to measure the electricity consumed or drawn at the consumer site 119. In another example, the data collector 204 can collect electrical data from the metering devices 118 located near or distributed for other areas or entities, such as commercial areas, industrial areas, facilities, or other areas with electrical distribution from the utility grid 100.

The electrical data can include electrical time-series data (e.g., voltage or current time-series) recorded at each metering device 118 over a time period. The data collector 204 can obtain a time-series data set recorded by a set of metering devices 118. The time-series data can represent a sequence of electrical data measured at successive points in time, such as voltage waveform data or current waveform data. The electrical time-series data can be used to compute pairwise correlations between the metering devices 118 or to perform other analyses discussed herein. In various cases, the data collector 204 can receive relatively high-resolution data, such as at least 1 kHz or 10 kHz of voltage data. In various cases, the electrical data discussed herein can be at least one of voltage data, current data, or power data, among other types of electrical information.

For example, the data collector 204 can obtain electrical waveform data (e.g., voltage waveform data or current waveform data) corresponding to electricity consumed by at least one load within the utility grid 100 and measured by at least one of the metering devices 118. The measured electricity (e.g., voltage measurement or current measurement) can represent or indicate the electrical consumption at the respective location of the metering device 118, such as the consumer site 119 (or residential home) or other areas. In this example, the metering system 201 can correspond to or be in communication with the metering device 118 via the network 140. The interface 202 can receive at least one of voltage waveform data or current waveform data from the metering device 118 periodically or in response to the metering device 118 measuring the electricity. The data collector 204 can obtain the electrical waveform data from the metering device 118 via the interface 202 in communication with the network 140.

In another example, the metering system 201 can correspond to or include the metering device 118, including the features or functionalities of the metering device 118. The metering system 201 (or the metering device 118) can include one or more sensors (e.g., voltage sensors) communicatively coupled with the metering system 201 or one or more components of the metering system 201. The one or more sensors can detect or measure the electricity (e.g., voltage or current) distributed over the utility grid 100 to generate at least one of the voltage waveform data or the current waveform data. The one or more sensors can perform the measurement at a predefined sampling rate according to their configurations or capabilities. The metering system 201 can obtain the electrical measurement over one or more time intervals. The data collector 204 can obtain, detect, or measure the electricity at various time intervals.

In some cases, the data collector 204 can collect the electrical data (e.g., time-series data set of metering devices 118) stored in the data repository 218 or other data storage. For example, the data collector 204 can store electrical data received from the metering devices 118 in the data repository 218. The data collector 204 can retrieve historical electrical data from the data repository 218 for processing by the one or more components of the metering system 201.

For simplicity and for purposes of providing examples herein, the data collector 204 can detect voltage or current associated with the electricity consumed by at least one load within (or electricity distributed on or over) the utility grid 100 during at least one of the time intervals, such as a first time interval. In some cases, the data collector 204 can detect the voltage and current synchronously or simultaneously. The metering system 201 (or component(s) of the metering system 201) can use the detected voltage or current to manage the grouping of metering devices 118 in transformer groups. In some configurations, both voltage and current information may be utilized synchronously to perform the features or operations discussed herein. In some other configurations, the metering system 201 may use voltage information or current information independently or alternatively. For purposes of providing examples, voltage data can be utilized, although the current data from the metering devices 118 may be utilized additionally or alternatively to the voltage data. The data collector 204 can store the collected data in the data repository 218.

The data collector 204 may process the electrical data obtained from the metering devices 118. For example, the data collector 204 can process raw electrical data (or electrical waveform) by applying predetermined filters to remove noise or certain frequencies from the collected data. The data collector 204 can compute the root-mean-square (RMS) values, averages, or other aggregates of the measured data over a (e.g., predetermined) time window. The data collector 204 can perform calibration for collected data, data scaling or normalization, or other data processing (or preprocessing) techniques not limited to those discussed herein.

The matrix generator 206 can generate at least one matrix (e.g., 2-dimensional (2D) or 3-dimensional (3D) matrix) using historical electrical data, e.g., the data collected by the data collector 204. The matrix can be a part of a dataset representing one or more electrical characteristics captured by metering devices 118 over time. For example, the matrix generator 206 can generate a matrix including columns and rows. The columns can represent the time series data recorded/captured for individual loads (e.g., from individual metering devices 118). The rows can correspond to time stamps or instances when the time series data is recorded. In some cases, the entries of the matrix can include RMS voltage values recorded by the metering devices 118 at predetermined sampling intervals (e.g., one sample every 15 minutes or other configurable sampling intervals). In some other cases, the entries of the matrix can include other data types recorded by the metering devices 118 (e.g., the framework described herein can include or utilize other data types). For instance, the dataset may include a matrix with columns representing other types of data (e.g., raw voltage values, current values, etc.) and the rows corresponding to time stamps. The matrix generator 206 can aggregate various information from the metering devices 118 to generate the dataset. In some cases, the matrix generator 206 can obtain or receive the dataset from (e.g., generated by) the metering devices 118. The matrix generator 206 can store the matrix in the data repository 218.

The metering system 201 can include at least one component, such as the data collector 204, the meter organizer 208, or other components of the metering system 201) to preprocess the dataset (e.g., the matrix) and perform data munging on the preprocessed data. Data munging can include or refer to cleaning, manipulating, or otherwise transforming data into a format suitable for analysis or other data-related tasks. In this case, by preprocessing and munging the data, the metering system 201 can determine the signals (e.g., voltage signals or current signals) and latitudinal and longitudinal coordinates (e.g. location) to be included or used at subsequent stage(s), such as to subdivide or group metering devices 118 in at least one transformer group. In some cases, the metering devices 118 can be configured or assigned with their respective coordinates. In such cases, the metering system 201 can receive the coordinates from the metering devices 118 along with the dataset, for example.

The meter organizer 208 can subdivide or group the metering devices 118 (e.g., for computational tractability) into N meter groups (e.g., N number of meter groups) according to the geographic proximity of the metering devices 118, or other parameters. The process for grouping the metering devices 118 into the respective meter groups can be a part of the preprocessing operation. In some cases, the metering devices 118 across different meter groups may not be grouped into the same transformer group. The geographic proximity may include but is not limited to at least one of service territory, distribution substation, distribution feeder, etc. The metering devices 118 within the geographic proximity can receive services from a predefined service provider (e.g., utility provider).

Using the service territory as an example, the meter organizer 208 can obtain an indication of various areas or regions associated with respective service territories. The meter organizer 208 can obtain the location (e.g., latitudinal and longitudinal coordinates) of the metering devices 118, e.g., the metering devices 118 may report the coordinates to the metering system 201. According to the location of each metering device 118, the meter organizer 208 can determine which service territory the metering device 118 resides in. The meter organizer 208 can group individual metering devices 118 into a respective meter group according to its service territory. Other parameters can be used to group the metering devices 118 into the meter groups, not limited to the geographic proximity. The other parameters used for grouping the metering devices 118 into the meter groups may include at least one of phases of the meters, nominal voltage of the meters, distance between meters, feeders associated with the meters, substation associated with the meters, etc.

In some cases, the meter organizer 208 can split the metering devices 118 into meter groups for load balancing purposes or to reduce computational processing, for example. In some other cases, the meter organizer 208 may skip splitting the metering devices 118 into meter groups and proceed to group the metering devices 118 into transformer groups.

For meters within each group, as part of the preprocessing operation, the meter organizer 208 can determine whether the metering devices 118 have similar (e.g., common) timestamps. If the metering devices 118 do not have common timestamps, the meter organizer 208 may generate or create a common-timestamp index and assign the values (or data) of each metering devices 118 to the common-timestamp index. In some cases, the meter organizer 208 may discard the meter data at timesteps if (e.g., electrical) data is missing or there is data where voltage=0 from at least one metering device 118. In some other cases, the meter organizer 208 may interpolate gaps in the data, such that the timesteps are present for the metering devices 118 (e.g., no timesteps are missing for any meter).

The meter organizer 208 can store identifications of metering devices 118 and their associated group (e.g., meter group) within a table, a matrix, or a list. For example, after determining a meter group for at least one metering device 118, the meter organizer 208 can assign or associate an indication (e.g., identification (ID), tag, or value) of the metering device 118 to an indication of the meter group (e.g., group number or value) in a table, matrix, or list. In some cases, the meter organizer 208 can send an indication of the groupings to the matrix generator 206 to generate a matrix, table, or list including associations between metering devices 118 and their respective meter groups. The meter organizer 208 (or the matrix generator 206) can store the list of associations in the data repository 218.

The matrix generator 206 can generate a meter-to-meter dependence matrix. The meter-to-meter dependence matrix may be referred to as a dependence matrix or covariance matrix. The matrix generator 206 may generate the meter-to-meter dependence matrix for metering devices 118 within geographic proximity (e.g., within a meter group). In some cases, the matrix generator 206 may generate the meter-to-meter dependence matrix for all metering devices 118 within the utility grid 100. The meter-to-meter dependence matrix can indicate the relationship between metering devices 118, such as metering devices 118 that interact, influence, or share data between each other in the utility grid 100.

For example, the matrix generator 206 can use at least one suitable correlation metric, such as Spearman's rank correlation or other correlation metrics, to compute a pairwise correlation (e.g., a dependency score or value) between at least a pair of metering devices 118. The matrix generator 206 can compute the pairwise correlations between the metering devices 118 according to the time-series data (e.g., voltage time-series data) from the respective metering devices 118 over a period of time. To form the (pairwise) correlations, the matrix generator 206 can split the time-series data into smaller windows (e.g., divide/separate the data into segments) to compute the correlations on individual data segments (e.g., correlations on minutes or hours of data between meters). The matrix generator 206 can execute at least one suitable segmentation technique to split the time-series data into the smaller windows depending on the predetermined timescale for distinguishing the differences between the signals from each pair of metering devices 118. For example, a one-day segment data between two meters may appear to be similar when using a rank-order correlation type, such as Spearman, but a 30-second segment data between the two meters may appear to be different. Hence, the matrix generator 206 may utilize one or more suitable segmentation techniques to identify similarities or differences between data segments.

The matrix generator 206 can select at least one filter or transformation to apply or pass over the time-series data, e.g., from the one or more smaller windows. For example, applying the filter can include determining a first-order difference in the time-series data (e.g., voltage time-series values). In another example, applying the filter can include performing a statistical operation (e.g., mean or skew) on a sliding or jumping subset of the samples in the times-series data to create a new time-series. Applying the filtering can allow for the created new time-series to provide improved characteristics in the data suitable for distinguishing differences after computing the correlations. In some cases, the matrix generator 206 can receive an indication of the at least one filter or transformation to apply from the administrator or utility operator. In some other cases, the matrix generator 206 may obtain filtered or transformed data from the data repository 218 (e.g., filtered and stored by the data collector 204 or other components or devices). With the filtered data (e.g., filtered time-series data within at least one window), the matrix generator 206 can perform at least one dependency measure used to compute the correlations. The dependency measure may be the Pearson Spearman correlation or other types of correlation techniques. The type of dependency measure can be predetermined or configured by the utility operator. Subsequently, the matrix generator 206 can aggregate or combine the correlations resulting from the executed dependency measure.

Accordingly, with the computed pairwise correlations, the matrix generator 206 can generate an N-meters×N-meters dependence matrix (e.g., covariance matrix) indicative of the correlation between various pairs of metering devices 118. The dependence matrix can include a dependency score for each pair of metering devices 118. The dependence matrix can include values ranging from 0 to 1, or other ranges of values according to the configuration. A relatively higher value (e.g., 1) in the dependence matrix can indicate a similarity between two metering devices 118, where the value of 1 corresponds to the correlation between a metering device 118 and itself. The matrix generator 206 can compute the dependence matrix between all metering devices 118 for each set of time-series splits (e.g., time-series windows). For example, if the split is 1 hour and there are 24 hours of data, the matrix generator 206 may generate a 3D matrix with dimensions [N_mtrs, N_mtrs, 24]. Because the size of [N_mtrs, N_mtrs] is desired for the final dependence matrix, the matrix generator 206 may select an aggregation method to collapse the third dimension, such as but not limited to mean, median, percentile, etc. By using the meter-to-meter dependence matrix, the metering system 201 (e.g., the meter organizer 208) can correlate or differentiate metering devices 118 from each other, such as grouping metering devices 118 with relatively higher correlations (or separating metering devices 118 with relatively lower correlations) into transformer groups.

The meter organizer 208 can cluster metering devices 118 into one or more estimated transformer groups. The meter organizer 208 can use the dependence matrix to group or cluster the metering devices 118 into one or more estimated transformer groups. For example, the meter organizer 208 can execute one or more clustering techniques to cluster individual metering devices 118 into transformer groups. The clustering techniques can include but are not limited to max rand index, maximum entropy, recursive binary optimization, etc.

The meter organizer 208 can use the max rand index clustering technique to determine whether pairs of metering devices 118 are correctly clustered with each other. For example, to perform the max rand index clustering technique, the meter organizer 208 can start with the generated dependence matrix (e.g., matrix [N_mtrs, N_mtrs]) to be separated into groups (e.g., transformer groups) of metering devices 118 under the same secondary transformer. The meter organizer 208 can (e.g., randomly) select a first meter and sort the row or column associated with the first meter from the dependence matrix into values from high to low. By sorting the row or column associated with the meter, the meter organizer 208 can form a list of various other meters associated with the first meter. The top meters from the list can represent the meters with the most correlated with the first meter. The meter organizer 208 can replace the dependence scores with the meter indices of the resulting sorting.

In further examples, as part of the max rand index clustering technique, the meter organizer 208 can loop through a group size of 2 through the highest number of meters that may belong in a group (e.g., referred to as “M_max”). For each of the number of meters, such as taking the first meter as an example, the meter organizer 208 can select the top (M_max−1) meters from the sorted vector of the first meter (e.g., from the sorted list), and store the indices of these top (M_max−1) meters as a vector, referred to herein as “A” for purposes of providing examples. The index of the first meter can be the first element of the vector A, e.g., if the two top meters for meter “3” are meters “7” and “12”, the vector A can be [3,7,12]. The meter organizer 208 can initialize a new, empty vector, referred to herein as “B” for purposes of providing examples. For each meter in the vector A, the meter organizer 208 can sort its dependence scores (e.g., according to the values), iterate the process for forming the vector A, and append these vectors associated with each meter in the vector A to vector B.

Subsequently, the modified rand index for the group size (e.g., group size of 2) can be computed as: mod_RI=numel(intersection(A,B))/numel(unique(B)), where “numel” corresponds to the number of resulting values. A relatively higher mod_RI, with a maximum value of 1, can indicate the more similar the most-correlated meters are to each other in the group. For instance, if three meters are selected, e.g., A_3=[3,4,5], A_4=[4,3,5], and A_5=[5,2,4], the vector B can be [3,4,5,4,3,5,5,2,4]. With the vector B, the meter organizer 208 can compute the mod_RI=numel([3,4,5])/numel([2,3,4,5])=0.75. If A_5=[5,3,4], B can equal [3,4,5,4,3,5,5,3,4], and mod_RI can be numel([3,4,5])/numel([3,4,5])=1, for example.

Responsive to the computation, the result can include a vector with mod_RI scores for grouping sizes 2-M_max. The grouping size selected can be the number of meters at which the max score occurs. In the case of tie scores, the second-smallest number of meters can be selected (e.g., if group sizes 4, 6, and 10 all had the same mod_RI score, 6 can be selected). The selected number of meters can be referred to as “M_grp” for purposes of providing examples herein. This meter and its associated top (M_grp-1) meters can be considered as or called a group, and thereby removed from the original dependence matrix. The operations for the max rand index clustering technique can be repeated until all meters have been grouped. If one meter remains, the one remaining meter can be deemed a singleton group.

Hence, the meter organizer 208 can form estimated groups of metering devices 118 belonging to the same transformer (e.g., secondary transformer) according to maximizing the rand index of each group. The rand index can represent the similarities between metering devices 118 within the group.

Next, the meter organizer 208 can use physics-based criteria to score the accuracy of each group formed (e.g., comparing in-group to out-group correlations). For example, the meter organizer 208 can compute the difference in the accuracy score when adding or removing at least one metering device 118 to or from the group. With the group having its highest accuracy score, the meter organizer 208 can save, store, or maintain the group. The meter organizer 208 may remove the saved group from the full set or list of metering devices 118. The meter organizer 208 can iterate the processes, including at least one of forming the estimated groups of metering devices 118, using the physics-based criterion, and saving (and removing) the group until all the metering devices 118 have been grouped or singleton meters remain.

In some cases, the meter organizer 208 can perform the maximum entropy clustering technique. For the maximum entropy clustering technique, the meter organizer 208 can initiate the operation with each metering device 118 as a singleton group, e.g., consider each metering device 118 as part of an individual group. For example, the meter organizer 208 can sort the 2D dependence matrix (e.g., from highest to lowest values) into a 1D vector containing the upper (or lower) triangle of the matrix. The meter organizer 208 can initialize each meter as a singleton group, e.g., each meter can form its own group to start. For each pair of the sorted meters, the meter organizer 208 can start with the highest-value pair. The meter organizer 208 may identify at least two groups (e.g., including one or more meters) associated with the pair of meters. The meter organizer 208 can determine whether the groups satisfy at least one of the criteria or properties to determine whether to merge the groups. The properties may include at least one of but not limited to statistics over the pairwise dependency measures defined by meters within each group exceeds a parameterized threshold (e.g., the pairwise matrix can have the size [n_mtrs_grp_1, n_mtrs_grp_2]), the size of the smaller one of the at least two groups does not exceed a parameterized threshold, or the size of the union of the two groups does not exceed a parametrized threshold. If one or more properties are satisfied, the meter organizer 208 can merge the groups. The meter organizer 208 can iterate the process for finding the groups that each of the pair of metering devices 118 belongs to until there are no other groups to merge.

In another example, if the groups satisfy one or more predefined heuristics (e.g., at least one of or both graph theoretic and conditions based on the raw dependency measure score), the meter organizer 208 can merge or combine the pair of groups into a single group. Otherwise, the meter organizer 208 can consider other pairs of groups for the pair of metering devices 118. The meter organizer 208 can iterate the operations/steps to perform Monte Carlo iteration, including taking another metering device 118 as a singleton group, obtaining another pair of metering devices 118, considering at least one pair of groups, and applying the one or more heuristics, to potentially merge other groups. The meter organizer 208 can iterate the operations until there is no pair of groups that satisfies the one or more heuristics for merging (e.g., no additional merging is possible).

In some aspects, the sorted pairs of meters from the dependence matrix [3-9, 3-2, 4-7, 4-9, . . . ] can be considered for performing the maximum entropy clustering technique. With the sorted pairs of meters, the meter organizer 208 can obtain resulting groups {3}, {9}, {2}, {4}, {7} of meters, among others. This resulting group can be obtained as part of the first iteration using the maximum entropy clustering technique. On a second iteration, for meter pair [3-9], the meter organizer 208 can obtain the resulting groups {3, 9}, {2}, {4}, {7}, etc. On a third iteration, for meter pair [3-2], the meter organizer 208 can obtain the resulting groups {3, 9, 2}, {4}, {7}, etc. On a fourth iteration, for meter pair [4-7], the meter organizer 208 can obtain the resulting groups {3, 9, 2}, {4, 7}, etc. On a fifth iteration, for meter pair [4-9], the meter organizer 208 can obtain the resulting groups {3, 9, 2, 4, 7}, etc., using the maximum entropy clustering technique.

In some configurations, the meter organizer 208 can utilize the recursive binary optimization clustering technique. For the recursive binary optimization clustering technique, the meter organizer 208 can set all the diagonal values in the dependence matrix to 0, such as to ensure that the metering device 118 is not considered dependent on itself. The meter organizer 208 can set up and solve a mixed-integer linear program (MILP).

For example, to solve the MILP, the meter organizer 208 can initialize a binary optimization variable for each non-zero element in the correlation matrix. The binary optimization variable may be set to a value depending on whether a pair (or a group) of metering devices 118 are considered to be related or dependent on each other. For instance, the binary optimization variable can take the value of 1 if the metering devices 118 are related and the value of 0 if the metering devices 118 are considered as not related. The meter organizer 208 can constrain the variables such that one variable per column of the correlation matrix may be non-zero. By constraining the variables, each metering device 118 can be assigned to one group (e.g., transformer group). The objective of the optimization problem can be to maximize the total global sum of the binary optimization variables times their corresponding dependence matrix values, for example.

Responsive to solving the MILP, the meter organizer 208 can send the results from the MILP to the matrix generator 206 to generate a matrix (e.g., sparse, binary values) of the same size as the dependence matrix. The meter organizer 208 can obtain the generated matrix from the matrix generator 206. Each value of the matrix can correspond to the final value of the optimization variable from the MILP. In some cases, the meter organizer 208 can perform the matrix generation using the results from the MILP. Subsequently, the meter organizer 208 can select a starting row in the matrix (e.g., the final result is starting-place dependent). The meter organizer 208 can traverse the selected row until a value of 1 is found. The row can represent a group (e.g., a current group when traversing the indexes of the row). The row index can represent the index of the metering device 118. The meter organizer 208 can add the row index associated with the value of 1 to the current group. The meter organizer 208 can recursively iterate, for example, traversing the row with the same index as the column for the position with value 1. When the value of 1 is identified when traversing the row, the column index where the value 1 is identified can be saved. The meter organizer 208 may visit or traverse each row once. The row index can correspond to the previously saved column index. The meter organizer 208 can determine that the group is completed when there are no more 1's to be found via this recursive traversal in the corresponding row. Completing the group can indicate that there are no other metering devices 118 to assign to the group. After the group is complete, the meter organizer 208 can revert back (or iterate the operations), starting on another row in the matrix until all the rows are traversed.

In some cases, the meter organizer 208 can execute a clustering technique to group or cluster the metering devices 118 (e.g., indexes or identification of the metering devices 118) into respective transformer groups. The meter organizer 208 can perform the clustering technique(s) until all the metering devices 118 are clustered into the transformer groups. The meter organizer 208 can save the predicted groups resulting from executing the clustering technique. The meter organizer 208 can remove the clustered/grouped metering devices 118 from the full set/list of metering devices 118.

In some cases, two or more clustering techniques can be utilized in different iterations (e.g., in the Monte Carlo framework). Each iteration can be performed with similar or different initial parameters or clustering techniques to potentially generate similar or different final clusters. In this case, the meter organizer 208 can combine the results from multiple clustering techniques to cluster the metering devices 118. For example, if two clustering techniques are executed, the meter organizer 208 can obtain at least two sets of predicted groups. The meter organizer 208 can compare these sets of groups to identify one or more groups sharing the same metering devices 118 (e.g., most-commonly-occurring groupings of metering devices 118 across the Monte Carlo iterations). In this case, the meter organizer 208 can save any predicted group which the clustering techniques agree on (e.g., produced the same groups or groups sharing the same metering devices 118). In some cases, the meter organizer 208 can save any predicted group sharing at least one metering device 118 from executing the clustering techniques. The meter organizer 208 can remove the metering devices 118 associated with the saved groups from the full set/list of metering devices 118.

The meter organizer 208 can iterate the operations of executing the clustering techniques, saving at least one predicted group, and removing the metering device(s) 118 from the full set until all metering devices 118 are extracted (from the full set) or the clustering techniques do not produce correlated results (e.g., does not result in similar group(s) using at least two different clustering techniques). In the case of having remaining meter groups (as opposed to singletons), the meter organizer 208 can select (or save) one or more groups from the clustering technique providing the highest average score (e.g., silhouette score) of all the groups formed in the clustering operations, e.g., executing the clustering techniques, saving predicted groups, removing meters from the full set, etc. The data processing system 150 can use the silhouette method for validating the consistency within the clusters of data obtained via utilization of the clustering techniques.

In some configurations, the metering system 201 can be configured to perform phase identification, for instance, using the algorithm, features, or computational process discussed herein. The metering system 201 can use the collected data from metering devices 118 to perform the phase identification. The metering system 201 can group the metering devices 118 into transformer groups according to the phase identification. In some cases, the phases of certain meters or groups of meters within the dependence matrix may be predetermined (or known). For the meters with unknown phases, for example, the metering system 201 may compute the phases for these meters based on the max correlation to one of the meters or groups of meters with the known phases. In another example, the metering system 201 can perform a k-means cluster on the meter data using N=3 which can correspond to the three phases.

In some configurations, the metering system 201 can cluster or group the metering devices 118 into respective transformer groups according to the location of the transformers (e.g., the secondary transformers or other upstream components) and the locations of individual metering devices 118 in the utility grid 100. An upstream component from the group of metering devices 118 can refer to a component between the metering devices 118 and the electrical source, such that the metering devices 118 receive electricity over the utility grid 100 from one or more upstream components. In this case, the meter organizer 208 can group the metering devices 118 into the transformer groups according to the distance between the metering devices 118 and the transformers (e.g., the secondary transformer). The meter organizer 208 can group the metering devices 118 by using the dependence matrix (e.g., covariance matrix) as part of a distance metric to perform silhouette clustering. An initial configuration can be created via a distance-informed random partition of the metering devices 118 to perform silhouette clustering, such as a predetermined maximum meter-to-transformer radius criterion. The predetermined radius can be 300 meters, 400 meters, 500 meters, etc., from the transformer. The dependence matrix can be used as part of the distance metric by assigning metering devices 118 with relatively high correlations to a transformer group corresponding to a transformer, where the metering devices 118 are within the predetermined radius from the transformer.

For example, the data collector 204 can obtain or acquire the locations of the transformers (e.g., secondary transformers) via global positioning system (GPS) coordinates. The data collector 204 can obtain the location of individual metering devices 118 via their respective GPS coordinates. In some cases, the data collector 204 can receive the locations of the secondary transformers or the metering devices 118 provided by an administrator of the utility grid 100. According to the locations, the meter organizer 208 can identify the metering devices 118 within the predetermined range of each transformer.

The meter organizer 208 can identify the correlations between the metering devices 118 to each other according to the dependence matrix. The meter organizer 208 can group the metering devices 118 with a relatively high correlation to each other and within the predetermined range of a transformer into the associated transformer group. In some cases, the meter organizer 208 may group at least one other metering device 118 that is outside the predetermined range of the transformer into the transformer group if the at least one other metering device 118 has a relatively high correlation with at least one metering device 118 within the transformer group. In some other cases, the meter organizer 208 may not assign any metering device 118 outside the predetermined range of the transformer to the transformer group.

In some cases, if at least one metering device 118 is located between the predetermined range of two transformers, the meter organizer 208 can determine its transformer group according to the correlation value (e.g., according to the dependence matrix) of the metering device 118 to at least one metering device 118 within one of transformer range (but not the other). For example, a first meter can be located within the predetermined range of a first transformer and a second transformer. The first transformer can be associated with a first transformer group. The second transformer can be associated with a second transformer group. The meter organizer 208 can identify a first correlation value between the first meter and a second meter in the first transformer group (and not in the second transformer group). The meter organizer 208 can identify a second correlation value between the first meter and a third meter in the second transformer group (and not in the first transformer group). The meter organizer 208 can compare the first and second correlation values. Responsive to the comparison, the meter organizer 208 can group the first meter into one of the first transformer group or the second transformer group including the meter (e.g., the first or second meter) that has a relatively higher correlation value with the first meter.

In some configurations, a Monte Carlo combination of the parameters or variables can be performed to select the transformer group for each metering device 118. For example, in the correlation stage for obtaining the dependence matrix (e.g., the covariance matrix), the matrix generator 206 can construct various pairwise correlations by performing multiple iterations with different parameters or variables. For instance, the meter organizer 208 may utilize different filters (or types of transformations), types of dependency measures, or types of aggregations for combining the correlations to output different covariance matrices. In some cases, the meter organizer 208 may use a different initial clustering technique to obtain an initial set of transformer groups, thereby changing the (e.g., pre-silhouette) results for the silhouette clustering stage. In the silhouette clustering stage, the meter organizer 208 can select different initial configurations of the metering devices 118 to iteratively cluster the metering devices 118 into transformer groups. The configuration can include (e.g., randomly) grouping meters, using historically provided groupings of meters (e.g., accurately recorded groupings), using the predetermined range of individual transformers, a predetermined range of the metering device 118, a minimum correlation value to consider the metering device 118 as part of the transformer group, etc. In some cases, the meter organizer 208 can use the silhouette clustering to refine the initial set of transformer groups to form an updated set of transformer groups according to the silhouette scores of the metering devices 118 (or the aggregate silhouette scores of the transformer groups).

By using the different parameters for the correlation stage or the different initial configurations for the silhouette clustering stage (e.g., Monte Carlo combinations), the meter organizer 208 can form sets of transformer groups. Each set of transformer groups may group metering devices 118 into different transformer groups depending on the selected parameters or configurations. Accordingly, the meter organizer 208 can obtain a (e.g., final) predicted transformer group for each metering device 118 by assigning the metering device 118 to the transformer most shared across the Monte Carlo combinations, e.g., the transformer that appeared the most across the sets of transformer groups. In some cases, the score generator 210 can use the proportion of the combinations as a heuristic confidence score for the metering device 118 being correctly placed in the predicted transformer group, e.g., how often the metering device 118 is assigned to the transformer across the sets compared to the number of sets. The number of sets can correspond to the number of Monte Carlo combinations or iterations performed by the metering system 201.

In some configurations, the meter organizer 208 can execute a first clustering technique (e.g., distance-based partition, max rand index, maximum entropy, or recursive binary) to group the metering devices 118 into an initial set of transformer groups. The meter organizer 208 can apply a second clustering technique (e.g., silhouette clustering technique) to refine the initial set of transformer groups by computing the silhouette scores (e.g., by the score generator 210) of the metering devices 118 as the metering devices 118 are moved to different transformer groups and forming an updated set of transformer groups according to the updated silhouette scores.

In various aspects, responsive to grouping the individual metering devices 118 in transformer groups, the metering system 201 can determine the accuracy of the groupings using or according to the score (e.g., silhouette or other types of scores). The score generator 210 can generate the silhouette score for each metering device 118. The silhouette score for each metering device 118 can represent or indicate the confidence or likelihood that the metering device 118 has been correctly grouped to the respective secondary transformer. The score generator 210 can generate or form a group score for each transformer based on an aggregate of the silhouette scores (e.g., median, mean, or average) of the metering devices 118 assigned to the transformer group. The meter organizer 208 may (re-)shuffle the groups or reassign metering devices 118 to other groups according to the computed silhouette scores.

For example, for each metering device 118, the metering system 201 (e.g., the score generator 210) can compute the changes to at least one of the group score or individual silhouette scores if the metering device 118 is moved to a different transformer group. The score generator 210 can perform the computation for all possible groups within a predetermined distance or radius. Performing the computation for all possible groups can refer to simulating moving the metering device 118 from one group to at least one other group within the predetermined distance. The simulation can be performed in a Monte Carlo manner. For example, as part of the Monte Carlo process, the input parameters used to construct the dependence matrix can be varied. Each variation can create a different dependence matrix. The result can include a 3D matrix having the size [N_mtrs, N_mtrs, N_variations], for example. In some cases, the initial grouping of meters used in the silhouette clustering may be varied. The Monte Carlo results can include a final estimate of the meter groups, where one estimate can be per combination of varying the input parameters and varying the initial grouping of meters, for example. The final meter-grouping estimate can be obtained from the Monte Carlo results, such as the most common grouping obtained among the Monte Carlo results.

In various aspects, the score generator 210 can compute a silhouette score for the initial or source group (e.g., the group that the metering device 118 is moved from) and a silhouette score for the destination or target group (e.g., the group that the metering device 118 is moved to). If the scores increase for both groups (or if the score of one group increases and the other group remains the same), the metering device 118 can be moved or relocated to the destination group. Otherwise, the metering device 118 can remain in the source group. The computation of the silhouette score can be a part of the Monte Carlo process.

The metering system 201 (e.g., the meter organizer 208 or the score generator 210) can reiterate the operations of simulating movements of metering devices 118 from one group to another and computing silhouette scores of the groups to determine whether to move the metering device 118. The meter organizer 208 can iterate moving the metering device(s) 118 to the destination group if the silhouette scores improved for at least one of (or both of) the source group and the destination group. The metering system 201 may terminate the reiteration when the silhouette scores of the groups are maximized (or may not be improved further).

For example, the score generator 210 can compute a first silhouette score for a first group (e.g., source group) and a second silhouette score for a second group (e.g., destination group). The score generator 210 can determine a third silhouette score for the first group and a fourth silhouette score for the second group if the at least one metering device 118 is to move from the first group to the second group. If at least one of the third silhouette score is greater than the first silhouette score or the fourth silhouette score is greater than the second silhouette score after moving the at least one metering device 118, the meter organizer 208 can perform the reassignment of the at least one metering device 118 to the different group (e.g., second group in this case). The meter organizer 208 can repeat the process of moving the metering devices 118 to different groups according to the silhouette score(s), such as until no other movement or reassignments result in an improvement of the silhouette scores for individual groups. The meter organizer 208 may reassign the metering devices 118 to other groups according to other parameters or criteria.

As discussed herein, the score generator 210 can store the generated scores in the data repository 218. The meter organizer 208 can store a list of transformer groups including an indication of the metering devices(s) 118 assigned to the respective transformer groups in the data repository 218.

The map manager 212 can generate, update, or otherwise manage a map of at least a portion of the utility grid 100. The map can show at least one of but not limited to the location of the metering device(s) 118, the location of at least one transformer, geographical terrains, buildings, roads, interactive elements, or other user interface elements. The map can provide an indication of the transformer groups associated with the metering devices 118. The indication can be in any configurable type of indicator, such as providing different patterns, values (e.g., identifications or tags), color coding, or other markers representing the respective transformer groups. In some cases, the map can be used to display other information related to the utility grid 100 or components of the utility grid 100, such as the meter ID, the transformer ID predicted for the metering device 118, the silhouette score computed for the metering device 118, the number of metering devices 118 under a particular transformer, the aggregated (e.g., minimum, mean, or median) silhouette score for the transformer group, etc.

To generate or update the map, the map manager 212 can obtain information from the metering devices 118, the transformer, the components of the metering system 201, or other components of the utility grid 100. For example, the map manager 212 may receive a base map or geographic information from a remote device or the data repository 218. The map manager 212 can obtain the coordinates of the metering devices 118 and the transformers. The map manager 212 can position icons representing the metering devices 118 on the base map according to the coordinates of the metering devices 118. In some cases, the map manager 212 may position icons representing the transformers on the base map according to the coordinates of the transformers. The map manager 212 can obtain a list of transformer groups from the data repository 218 or the meter organizer 208. The map manager 212 can provide an indication (e.g., color, tag, value, or pattern) of the associated transformer group to each icon representing the metering device 118. When the metering device 118 moves from one transformer group to another, the map manager 212 can update the indication of the associated transformer group to reflect the change.

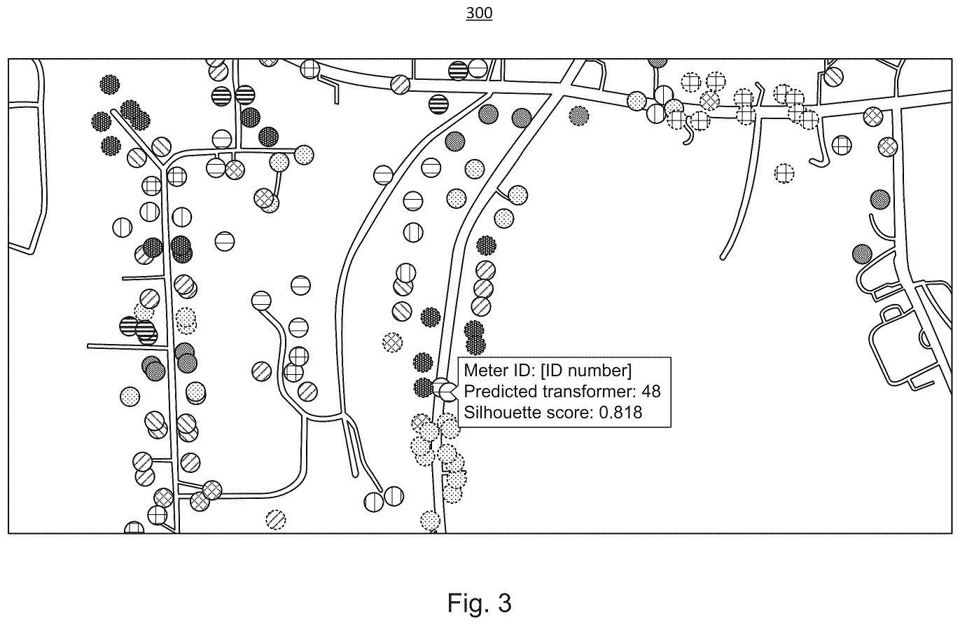

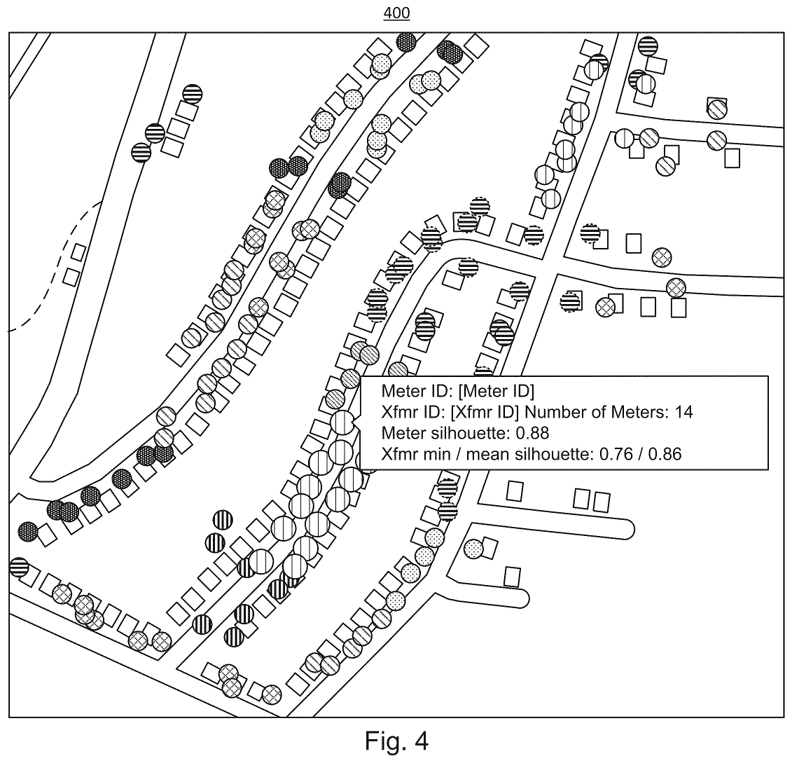

The map manager 212 can provide the map for display via a display device of the metering system 201 or other devices, such as the data processing system 150 or a client device remote from the utility grid 100. In some cases, one or more elements on the map can be configured as interactive elements. For example, the icons of the metering devices 118 can be interactive elements such that upon receiving an indication of interaction with an icon, the map manager 212 can display information related to the metering device 118, as described above. The map manager 212 can expand or narrow the view of the map based on user interactions with the user interface. The map manager 212 can update the map in response to at least one metering device 118 added or removed from the utility grid 100. In some cases, the map manager 212 can update the map in response to receiving inputs from the administrator, such as the reassignment of at least one metering device 118 to another transformer group, configuration to the user interface elements, etc. The map manager 212 can perform other operations to manage the user interface of the map, not limited to those discussed herein. Examples of the generated map can be described in conjunction with but not limited to FIGS. 3-4.

The action manager 214 can select or manage actions to be performed on the utility grid 100, such as sending information or instructions to components or devices in or remove from the utility grid 100. In some cases, the action may include sending the data of the map to other devices. For example, the action manager 214 can obtain the map generated or updated by the map manager 212. The action manager 214 can initiate an action to provide data of the map to a display device of the metering system 201, the data processing system 150, the client device, or other devices to display the map.

In some cases, the action can include notifying the map manager 212 of changes in the utility grid 100. For example, the action manager 214 may receive updates or an indication of changes in the utility grid 100 (e.g., from components of the utility grid 100 or from the administrator). The changes may include at least one metering device 118 being added or removed from the utility grid 100, maintenance time (or downtime) for at least one transformer or area in the utility grid 100, relocation of grid devices, or other changes to the grid infrastructure. In response to the changes, the action manager 214 can initiate an action for signaling or triggering the map manager 212 to update the map. In some cases, the action can include notifying the client device (or administrator device) of any updates to the map, e.g., notification regarding changes to the transformer group according to the silhouette score, updated silhouette scores, status of metering devices 118, status of the transformers, etc.

In certain situations, the action manager 214 may receive an indication of an event affecting a transformer. The event may be a power outage, maintenance, a predicted electrical spike, changes in the characteristics of electrical distribution to the metering devices 118, or any other types of events. The action manager 214 may perform a lookup in the data repository 218 to identify the metering devices 118 in a transformer group corresponding to the transformer associated with the event. Responsive to at least one of the events, the action manager 214 can select a predetermined action to be performed (e.g., by the grid controller 216) on the utility grid 100. For example, the action may include at least one of disabling the metering devices 118, restarting the metering devices 118, or updating an application executed by the metering devices 118, to name a few.

The grid controller 216 can perform the action selected or determined by the action manager 214. The grid controller 216 can perform the action for components or devices within the utility grid 100. For example, responsive to the event associated with at least one transformer, the grid controller 216 can perform the selected action on the one or more metering devices 118 in the transformer group corresponding to the transformer.

In some cases, by identifying the correct meters under a certain (e.g., secondary) transformer, and having access to the time-series data of the meters, the grid controller 216 can determine the time-varying loading on the transformer as a summation of the individual meters' loads. In this case, the grid controller 216 can allow for accurate asset-health estimation and planning for future hardware upgrades. The grid controller 216 can send signals to the administrator or the utility grid operator indicating the estimated health or notification recommending upgrading the hardware of one or more meters or the transformers.

In another example, the grid controller 216 can send at least one signal to the one or more devices to provide the map data for display on the one or more devices. The grid controller 216 may send alerts or notifications to the one or more devices. In some cases, the grid controller 216 may control the electrical distribution (or load balancing) to one or more transformers according to the electrical consumption of the metering devices 118 and their associated transformer groups. For example, the grid controller 216 (e.g., data collector 204) can receive an indication of electrical usage of at least one metering device 118. If the metering device 118 is consuming an excessive amount of electricity (e.g., over a predetermined threshold), the grid controller 216 can increase the amount of electricity distributed to the transformer corresponding to the transformer group of the metering device 118. The grid controller 216 can perform other actions to control or manage the operations of the utility grid 100.

The data repository 218 can include, store, or maintain information or data collected, measured, obtained, or otherwise received as discussed herein. The data repository 218 may be referred to as a data storage, database, memory device, etc. The data repository 218 can include at least a utility grid data storage 220, an identifier storage 222, a matrix storage 224, a score storage 226, a map storage 228, and an action storage 230. The data repository 218 can include other types of storage to store information for meter-to-transformer connectivity (e.g., clustering metering devices 118 into transformer groups). In some cases, information stored in the data repository 218 can be uploaded to or synced with the data repository 236 of the data processing system 150, among other cloud storage devices, or downloaded to the data repository 218 for processing. In some other cases, the information stored in the data repository 218 may be local to the metering system 201. The data repository 218 can be accessed by one or more components (e.g., data collector 204, matrix generator 206, meter organizer 208, score generator 210, map manager 212, action manager 214, or grid controller 216) of the metering system 201, or at least one external or remote device, such as other metering systems within the utility grid 100, the data processing system 150, etc.

The utility grid data storage 220 can include, store, or maintain information related to the utility grid 100 obtained, measured, or detected by the metering system 201 (e.g., interface 202 or data collector 204). For example, the utility grid data storage 220 can store electrical data received or measured by the data collector 204, such as the voltage waveform data or current waveform data measured by the metering system 201. The utility grid data storage 220 can store timestamps of when the data are logged or stored in the data repository 218. In some cases, the utility grid data storage 220 can include the identifier of the metering system 201, for instance, to be provided to the data processing system 150 during data transmission. In some other cases, the utility grid data storage 220 can include the geographical location of the metering system 201.

The identifier storage 222 can include, store, or maintain identifiers, values, or tags representing components or devices within the utility grid 100. For example, the identifier storage 222 can store the identifiers of metering devices 118. The identifier storage 222 can store the identifiers of transformers. The identifier storage 222 may store the identifier of the metering system 201, or other devices within the utility grid 100, e.g., for communication purposes.

The matrix storage 224 can include, store, or maintain matrixes generated or formed by the matrix generator 206. The matrix storage 224 can store lists, arrays, or tables discussed herein. The stored matrix may include the matrix of the dataset used for subdividing meters into meter groups, the meter-to-meter dependence matrix, the correlation matrix (e.g., for the recursive binary optimization clustering technique), or other matrixes discussed herein. The matrix storage 224 can store a table or a list of metering devices 118 (e.g., listing the meter identifiers). The matrix storage 224 may store a list of transformers (e.g., listing the transformer identifiers). The matrix storage 224 may store at least one of a list of meter groups or a list of transformer groups. In the list of transformer groups, for example, each row can represent a transformer of the group and the columns can represent the metering devices 118 assigned to the transformer group. In some cases, the matrix storage 224 may store the matrixes generated by the data processing system 150 or other remote devices.

The score storage 226 can include, store, or maintain the scores or values generated by the score generator 210 or the data processing system 150, among other devices. For example, the score storage 226 can store the silhouette score of the metering devices 118. The score storage 226 can store the (e.g., aggregated) silhouette score of the transformer groups. The score storage 226 can update the scores of the metering devices 118 or the transformer groups when at least one metering device 118 is moved between different transformer groups. In some cases, the score can be a part of a list or a matrix stored in the matrix storage 224. For example, the matrix may include the identifier of the metering device 118 and the associated silhouette score. In another example, the matrix may include the identifier of the transformer and the associated silhouette score.

The map storage 228 can include, store, or maintain data of the map managed by the map manager 212. The map data can include geographic information, coordinates of the metering devices 118, coordinates of the transformer, graphical user interface elements for presenting the map, etc. The map data may include a setting interface for users to configure the appearance of the map, including but not limited to the icon sizes, colors, patterns representing the assigned transformer groups, filters, etc.

The action storage 230 can include, store, or maintain various actions selectable by the action manager 214 or executable by the grid controller 216. The actions can include or correspond to executable codes, instructions, or commands for execution by the grid controller 216. The actions can be predetermined by the operator or the administrator of the utility grid 100. The action storage 230 can update the stored actions, such as adding, removing, or changing the actions according to instructions or configurations from the administrator.

In some cases, the metering system 201 can be different from the data processing system 150, for instance, the metering system 201 can correspond to or be associated with at least one of the metering devices 118. In this case, the data processing system 150 can be remote from the utility grid 100 and the metering systems. The data processing system 150 can receive data from the one or more metering systems, such as the metering system 201. The data received from the metering system 201 may include, for instance, at least a portion of the collected electrical data (e.g., voltage data, current data, or power data), the one or more matrixes generated by the matrix generator 206, the groups clustered by the meter organizer 208, the scores generated by the score generator 210, the map generated by map manager 212, etc. The metering system 201 can provide the data to the data processing system 150 for processing (or delegate certain processing tasks).

The data processing system 150 can include one or more components for grouping the metering devices 118 into groups (e.g., meter groups or transformer groups), among other functionalities discussed herein. The one or more components of the data processing system 150 can include, for instance, at least one meter organizer 232, at least one map manager 234, at least one data repository 236, or other components, such as one or more components similar to the metering system 201. The data repository 236 may be referred to as a memory device of the data processing system 150 or a remote database relative to the metering system 201. Each of the components (e.g., meter organizer 232, map manager 234, or data repository 236) of the data processing system 150 can be implemented using hardware or a combination of software and hardware. The data processing system 150 can include one or more components configured to one or more features or functionalities similar to the metering system 201.

The meter organizer 232 can be configured to perform features or functionalities similar to the meter organizer 208. For example, the meter organizer 232 may receive the data collected by the data collector 204 or the matrixes generated by the matrix generator 206. The meter organizer 232 can process the collected data to subdivide metering devices 118 into meter groups according to the geographical proximity. For each meter group, the meter organizer 232 can cluster the metering devices 118 within the meter group into one or more transformer groups according to one or more clustering techniques. The meter organizer 232 can rearrange or move the metering devices 118 to different transformer groups according to the silhouette scores (e.g., generated by the score generator 210). In some configurations, the data processing system 150 can include components to perform features or functionalities of the data collector 204, the matrix generator 206, the score generator 210, or other components of the metering system 201.

The map manager 234 can be configured to perform features or functionalities similar to the map manager 212. For example, the map manager 234 can obtain the completed transformer groups from the meter organizer 232. The completed transformer groups can include or indicate one or more metering devices 118 assigned to the corresponding transformer (e.g., secondary transformer). The map manager 234 can generate a map including the location of at least the metering devices 118. The map manager 234 can provide an indication of the transformer group assigned to individual metering devices 118. The map manager 234 can provide the map data to be displayed on a display device of the data processing system 150 or other devices within the network 140.

The data repository 236 can include, store, or maintain information related to the meter-to-transformer connectivity. The data repository 236 can include at least utility grid data storage 238, identifier storage 240, and map storage 242. The data repository 236 can include other types of storage for storing information related to the meter-to-transformer connectivity, such as information similar to the data repository 218. For example, the utility grid data 238 may include, store, or maintain electrical data collected from the metering devices 118 or other information similar to the utility grid data storage 220. The identifier storage 240 can include, store, or maintain the identifiers of the metering devices 118 and the transformers. The identifier storage 240 may include other information similar to the identifier storage 222. The map storage 242 can include, store, or maintain map data managed by the map manager 234. The map storage 242 can include other information similar to the map storage 228. The data repository 236 can include other storage or memory devices to store local data of the data processing system 150 or data from external devices.

FIG. 3 depicts an example map 300 for estimated meter grouping (e.g., grouping of metering devices 118 into transformer groups). The map 300 can be generated, updated, or otherwise managed by the metering system 201 (e.g., map manager 212) or the data processing system 150 (e.g., map manager 234). As shown, the map 300 of meter groupings can be provided, where each group can include an associated set of metering devices 118. Each meter location can be shown with a circle as a configurable icon. In some cases, the meter location can be presented in other shapes, sizes, or indications. The metering devices 118 assigned to the same transformer (e.g., secondary transformer) can be assigned with a similar unique meter identifier (ID), color (e.g., color repetition may be inevitable), shape, pattern, or other formats for a visual representation to the utility operator. The visual representations can be configurable by the utility operator. The map 300 can be displayed or presented to the operator as a graphical user interface (GUI) via a display device of the operator device. In some cases, the metering system 201 or the data processing system 150 may be the operator device. The operator can interact with interactive elements of the GUI. For example, responsive to user interaction (e.g., clicking or pressing) with a certain meter representation (e.g., circle), the GUI can yield or display information related to the metering device 118 via a pop-up box, text overlay, notification, or other types of presentation. The information related to the metering device 118 can include but is not limited to the meter ID, the estimated transformer number (e.g., predicted transformer) of the transformer group, or the silhouette score of the respective metering device 118.

FIG. 4 depicts another example map 400 for estimated meter grouping. The map 400 can be generated by the metering system 201 or the data processing system 150. As shown, the map 400 of meter groupings can be provided, where each group can include an associated set of metering devices 118. Various elements or features of the example map 400 can be similar to the elements of the example map 300. For example, each meter location can be shown with a circle. The metering devices 118 assigned to the same transformer (e.g., secondary transformer) can be assigned with a similar unique meter ID, color (e.g., color repetition may be inevitable), shape, or other formats for a visual representation to the utility operator. The map 400 can be displayed or presented to the operator via the GUI of the operator device. The operator can interact with the GUI, for instance, responsive to user interaction (e.g., clicking or pressing) with a certain meter representation (e.g., circle), the GUI can yield or display the meter ID, the estimated transformer number (e.g., predicted transformer), and the silhouette score of the respective metering device 118. In some cases, as shown in map 400, the GUI can display an identifier of the transformer (e.g., transformer identifier) associated with the metering device 118 (e.g., the transformer that relays electricity over the utility grid 100 for the respective group of metering devices 118). The GUI can display the total number of metering devices 118 assigned to the same transformer (e.g., associated with the transformer identifier). The GUI can display at least one of the minimum or the mean silhouette score of the transformer associated with the metering device 118, such as responsive to the user interaction with the meter representation on the map 400. The map 400 may include other information to be displayed to the operator or administrator, not limited to those discussed herein.

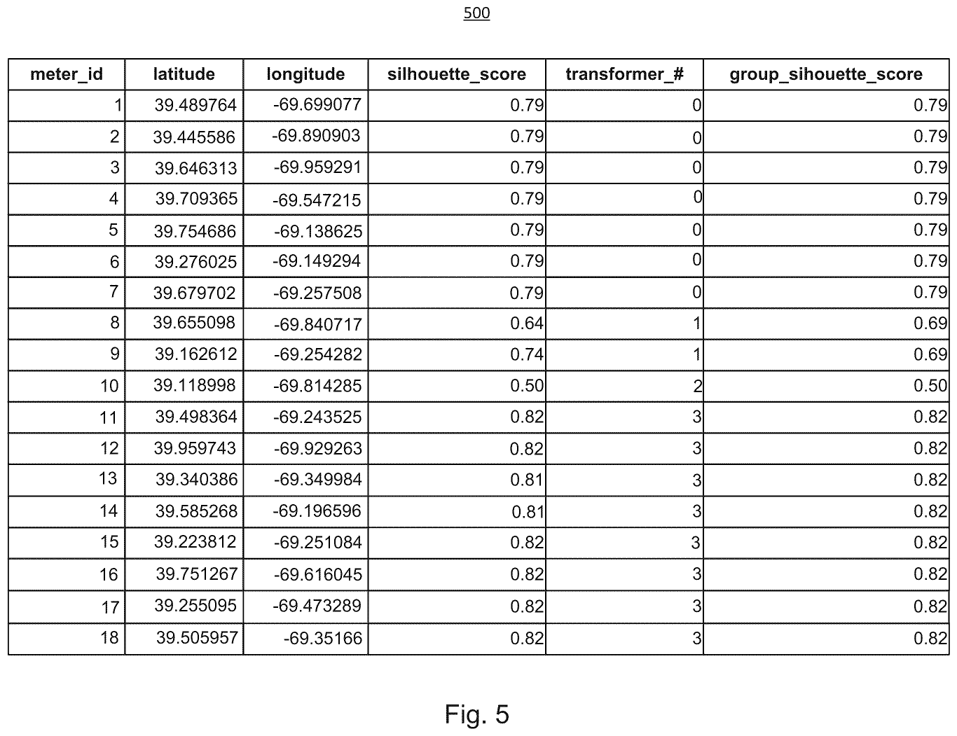

FIG. 5 depicts a table 500 of an example tabular output of meter grouping results. For example, the table 500 can include some grouping results of metering devices 118 from at least one of but not limited to FIGS. 3-4. The data from table 500 can include at least one of the meter ID, latitude/longitude coordinates, silhouette score, estimated transformer number, group silhouette score, etc., for the metering devices 118.

According to the aforementioned techniques for estimating meter-to-transformer connectivity, the systems and methods of the technical solution can use routinely collected data from the metering devices 118 (e.g., or other components of the utility grid 100), thereby minimizing or avoiding the utilization of additional data streams or sensors. The systems and methods can be data-driven, hence, the results can be updated in response to obtaining new data. The systems and methods, including the metering system 201 or the data processing system 150, can alleviate manual cataloging (e.g., by the operator(s)) of each grouping of metering devices 118.

In some cases, additionally or alternatively to the three clustering techniques discussed hereinabove, other statistical or machine learning techniques may be utilized to estimate the meter groupings. In some cases, an alternative method for performing the various tasks described herein can include having the utility (e.g., metering device 118) transmit an impulse signal via the system (e.g., utility grid 100), measure the frequency response of each distribution pathway, and subsequently cluster meters based on similar frequency responses, for example.

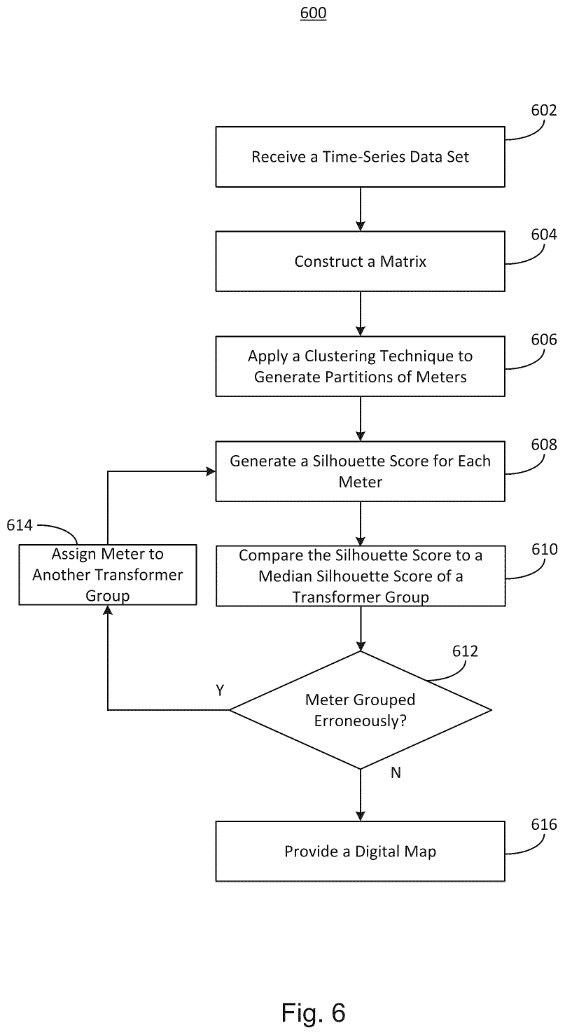

FIG. 6 depicts a flow diagram of an example method 600 for meter-to-transformer connectivity. The example method 600 can be executed, performed, or otherwise carried out by the one or more components of the utility grid 100 (e.g., computing device, metering device 118, data processing system 150, or other devices), the system 200 (e.g., data processing system 150 or metering system 201), or computing device 800, etc. Although the steps of the method 600 are shown to be performed by one of the metering system 201 or the data processing system 150, certain steps discussed herein can be performed by either one of the metering system 201 or the data processing system 150. The method 600 can include receiving time-series data set, at ACT 602. At ACT 604, the method 600 can include constructing a matrix. At ACT 606, the method 600 can include applying a clustering technique to generate partitions of meters. At ACT 608, the method 600 can include generating a silhouette score for each meter. At ACT 610, the method 600 can include comparing the silhouette score to a median silhouette score of a transformer group. At ACT 612, the method 600 can include determining whether at least one meter is grouped erroneously. At ACT 614, the method 600 can include assigning the meter to another transformer group. At ACT 616, the method 600 can include providing a digital map.

In further detail, at ACT 602, the metering system can receive time-series data set of voltage measured by meters (e.g., metering devices 118) at a plurality of loads in an electricity distribution grid. The time-series data set can include a (e.g., second) matrix having a first dimension corresponding to timestamps and a second dimension corresponding to root mean square voltage values recorded by the meters at a fixed sampling interval. The fixed sampling interval may be every minute, 10 minutes, 15 minutes, etc. The metering system can obtain the time series data directly from the meters or retrieve historical time-series data set from a data repository.

At ACT 604, the metering system can construct or generate a matrix based on or according to the time-series data set. The matrix can include values that indicate similarities between pairs of meters of the plurality of meters. The matrix may be referred to as or include a dependence matrix or a covariance matrix. In some cases, the metering system may use a correlation metric to compute the pairwise correlation between the meters. For example, the metering system may use Spearman's rank correlation or other types of correlation techniques (e.g., Pearson's correlation coefficient, distance correlation, or polychoric correlation) to compute the pairwise correlation between the meters according to the time-series data, such as characteristics or trends of the RMS values. The metering system can aggregate the pairwise correlations to generate the covariance matrix (e.g., dependence matrix), where the values of the covariance matrix indicate the similarities between the meters.

In some cases, the metering system can generate the matrix with a Monte Carlo of combinations of at least two of: a plurality of window sizes, filters, similarity metrics, or aggregation techniques to combine correlations between the plurality of meters. The Monte Carlo of combinations can refer to generating the matrixes using different combinations of the parameters or variables. For example, the metering system can split the time-series data into smaller windows with predetermined or selected window sizes for assessing the similarities between meters according to the time-series data. Different window sizes can be used for one or more iterations of the Monte Carlo. The metering system may apply a filter or transformation to the (e.g., voltage) data. Different types of filters may be used for the one or more iterations of the Monte Carlo. The metering system can utilize a predetermined or selected dependency measure to compute the pairwise correlations between pairs of meters. The correlation metric may include Spearman's rank correlation or other types of metrics. The metering system can aggregate the correlations to generate the covariance matrix (e.g., dependence matrix). The metering system can identify the similarities between at least two meters based on the values from the covariance matrix. For instance, the values can range between 0 and 1 in the dependence matrix, where 0 represents a relatively low correlation and 1 represents a relatively high correlation. The generation of the covariance matrix can be a part of the Monte Carlo of combinations.

At ACT 606, the metering system can apply one or more clustering techniques to partition the meters to generate partitions of meters. The partitions of meters may refer to initial transformer groups assigned to the meters, which can be scored and updated according to the silhouette scores. In some cases, the metering system can cluster the meters by executing two or more clustering techniques. The clustering technique can include but is not limited to at least one of a distance-based partition, a max rand index, a maximum entropy, or a recursive binary optimization applied to the matrix.

For example, the metering system can apply the two or more clustering techniques to the covariance matrix. Taking two clustering techniques (e.g., first and second clustering techniques) as an example, the metering system can generate two partitions (e.g., sets or groups) of the meters. The metering system can iteratively execute the clustering techniques to obtain partitions that share the same meters. These partitions sharing the same meters can be saved and later used for finalizing the transformer groups. The meters that have been partitioned can be removed from a pool (or full set) of meters, such that the remaining meters in the pool can be clustered or partitioned. In some cases, if there are remaining partitions, the metering system can select (and save) the partitions that produce the highest silhouette score (e.g., average silhouette score) of all the partitions formed by applying the clustering techniques.

In some cases, the metering system can execute iterations of clustering techniques to determine a first partition and a second partition for each meter. If the first partition is the same as the second partition, the metering system can assign the meter to the partition. Otherwise, the meter can remain in the pool of meters for clustering (or partitioning). The metering system can iterate the operations of the clustering techniques until all meters are extracted from the pool (or if the clustering techniques do not produce a similar partition for the remaining meter(s)).

Each partition may include similar or different groupings of meters for the partitions depending on the combination of clustering techniques. In some cases, the metering system can adjust (e.g., first) one or more parameters used to create the matrix to determine an updated matrix for applying the clustering techniques. Applying the clustering techniques to the updated matrix can result in meters assigned to different partitions.

At ACT 608, the metering system can generate a silhouette score for each of the meters. In some cases, the metering system may generate the silhouette score for each meter in the matrix to group the meters into transformer groups via the clustering techniques applied to the matrix. The silhouette score of each meter can represent the confidence that the meter is accurately grouped into the transformer group (e.g., the initial transformer group). For example, after clustering the meters into transformer groups using the clustering techniques, the metering system can generate the silhouette score for each meter according to one or more parameters, such as the distance between the meter and the transformer, the characteristics of the time-series data between the meter and one or more other meters in the (e.g., initial) transformer group, etc. The silhouette score for a respective meter with respect to the currently assigned group can be defined as the difference between the in-group correlation and the max out-group correlation, divided by the max of those two values. The silhouette score can include a range between −1 to 1, for example. The in-group correlation can refer to the average correlation value between a respective meter and other meters in the group that the respective meter is assigned to. The out-group correlation can refer similarly to the in-group correlation, but for other groups that the respective meter is not assigned to (e.g., outside the group associated with the respective meter). The metering system can compute the silhouette score of the transformer group based on an aggregate of the silhouette scores of the meter(s) within the transformer group. The aggregate silhouette score can include the average, median, or mean silhouette score, among other types of aggregate.

In some aspects, the metering system can adjust (e.g., second) one or more parameters of at least one of the clustering techniques to determine an updated silhouette score. The metering system may use the matrix (e.g., prior to the update) or the updated matrix for the clustering techniques within the adjusted parameters. With at least one of the updated first parameter(s) or the updated second parameter(s), the metering system can compute an updated silhouette score for each meter in the matrix (and each transformer group or partition). In some cases, the metering system can generate an updated subset of meters that are associated with the transformer according to the silhouette score. For example, by adjusting the first or second parameter(s), the metering system may associate each meter with the same or different transformer. In such cases, the metering system may cluster the meters into the transformer groups according to the parameters that result in the meters (or the transformer groups) yielding the highest silhouette scores.

In various configurations, the metering system can use the covariance matrix as a distance metric to perform silhouette clustering. For example, the metering system can apply a distance-based clustering techniques of the various clustering techniques to partition the meters to generate partitions of the meters. The meters for clustering or partitioning to a partition (e.g., initial transformer group) can be within a predetermined range from a corresponding transformer. In this example, the metering system can partition the meters according to the covariance matrix and the distance between each meter and the transformer. After performing the silhouette clustering, the metering system can obtain a set of partitions of meters. The metering system can generate the silhouette score for each of the plurality of meters via the clustering techniques applied to each of the partitions, e.g., generate the silhouette score for each meter in the partition formed by the silhouette clustering.

In some cases, the metering system can generate the silhouette score for each meter via the plurality of clustering techniques with a Monte Carlo of a plurality of (e.g., different) initial configurations of meters. For example, the metering system can execute the Monte Carlo of combinations of parameters by changing the parameters of at least one of the correlation stage (e.g., to obtain a different covariance matrix) or the silhouette clustering stage (e.g., to obtain a different set of partitions) in at least one other iteration. The metering system can perform a predetermined number of Monte Carlo of combinations to obtain a number of sets of partitions. The one or more meters may be partitioned into the same or different partitions between the sets depending on the combination of parameters. In this case, the metering system can group each meter to the most commonly occurring transformer across the Monte Carlo of combinations.

Accordingly, the metering system can determine a confidence score for each meter placed in a partition of a plurality of partitions (e.g., transformer group of a plurality of transformer groups) based on a count of the combinations of the Monte Carlo of combinations that place the meter into the (e.g., same) transformer group or partition. The metering system can generate a relatively higher confidence score for the meter in a transformer group if the meter (e.g., mostly) appears in the same transformer groups across the Monte Carlo of combinations. If the meter appears (e.g., proportionally) in different transformer groups across the Monte Carlo of combinations or does not appear in any transformer group, the metering system may generate a relatively low confidence score for the meter.

At ACT 610, the metering system can compare the silhouette score to a median silhouette score of a transformer group (e.g., the partition). For example, the metering system can compute an aggregate silhouette score for each transformer group. The aggregate silhouette score may be an average, median, or other types of aggregate of the silhouette scores from the meters within the transformer group. For purposes of providing an example, the aggregate silhouette score can be the median silhouette score, although other types of aggregate may be used. The median silhouette score can represent confidence that the meters belong to the transformer group.

At ACT 612, the metering system can determine whether at least one meter is grouped erroneously. The metering system can compare the silhouette score of each meter to the median silhouette score of the transformer group to determine whether the meter is erroneously grouped. For example, the meter in a first transformer group can be associated with a first silhouette score. The metering system can detect that the meter is erroneously grouped into the first transformer group based on a comparison of the first silhouette score of the meter and a first median silhouette score of the first transformer group. If the first silhouette score is below the first median silhouette score, the metering system may determine that the meter is grouped erroneously. In some cases, the metering system may compare the first silhouette score to a predetermined threshold (e.g., predetermined median silhouette score) to determine whether the meter is grouped erroneously. Responsive to detecting that the meter is grouped erroneously, the metering system can proceed to ACT 614.

At ACT 614, the metering system can assign the meter to another transformer group. For example, responsive to the detection, the metering system can remove the meter from the first transformer group and insert the meter into a second transformer group of the plurality of transformer groups. The removal and insertion of the meter into the second transformer group can be a part of a simulation for generating simulated silhouette scores. After moving the meter to the second transformer group, the metering system can determine a second silhouette score of the meter inserted into the second transformer group (e.g., generate another silhouette score as described in conjunction with ACT 608). If the second silhouette score is greater than the first silhouette score, the metering system may maintain the meter in the second group.

In another example, the metering system may determine a second median silhouette score for the second transformer group after inserting the meter. If at least one of the second median silhouette is greater than the first median silhouette or the second silhouette score is greater than the first silhouette score, the metering system can maintain the meter in the second transformer group.

In further examples, the metering system can simulate moving the meter into other transformer groups (e.g., third transformer group, fourth transformer group, or fifth transformer group) and computing the updated silhouette scores of the meter. If any of the updated silhouette scores are greater than the first silhouette score and the second silhouette score, the metering system can move the meter to the respective transformer group. The metering system can repeat the process of simulating the movement of each meter into different transformer groups until the silhouette score of the meter or the median silhouette score of the transformer group is maximized. The metering system can proceed to ACT 616 in response to maximizing the silhouette score(s) or when there are no erroneously grouped meters.

At ACT 616, the metering system can provide a digital map for output via a graphical user interface. The digital map can include an indication of at least a subset of meters of the plurality of meters associated with a transformer of the plurality of transformer groups generated based on the plurality of clustering techniques applied to the matrix. For example, the metering system can generate the graphical user interface displaying the digital map with the location of one or more meters. The metering system can provide an indication of the transformer group associated with the one or more meters. The indication can be configurable, such as color code, pattern, or value. The metering system can include other information in the graphical user interface, which may be configured by the utility operator or administrator of the system.

In some cases, the metering system may receive an indication of an event associated with a transformer of the plurality of transformer groups. The metering system can identify, via a lookup (e.g., in the data repository storing a list of transformer groups and their assigned meters), a second plurality of meters grouped in the transformer group of the plurality of transformer groups that correspond to the transformer associated with the event. Responsive to the event, the metering system can perform an action on the second plurality of meters. The action can include at least one of but not limited to disabling the plurality of meters, restarting the plurality of meters, or updating an application executed by the plurality of meters.

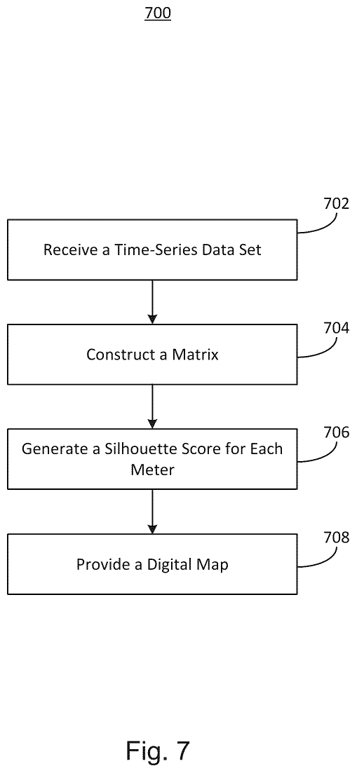

FIG. 7 is a flow diagram of another example method 700 for meter-to-transformer connectivity, in accordance with an embodiment. The example method 700 can be executed, performed, or otherwise carried out by the one or more components of the utility grid 100 (e.g., computing device, metering device 118, data processing system 150, or other devices), the system 200 (e.g., data processing system 150 or metering system 201), or computing device 800, etc. Although the steps of the method 600 are shown to be performed by one of the metering system 201 or the data processing system 150, certain steps discussed herein can be performed by either one of the metering system 201 or the data processing system 150. The method 700 can include receiving a time-series data set, at ACT 702. At ACT 704, the method 700 can include constructing a matrix. At ACT 706, the method 700 can include generating a silhouette score for each meter. At ACT 708, the method 700 can include providing a digital map.

In further detail, at ACT 702, the metering system can receive a time-series data set of voltage measured by meters at a plurality of loads in an electricity distribution grid. The time-series data set can include a matrix having a first dimension corresponding to timestamps and a second dimension corresponding to root mean square voltage values recorded by the meters at a fixed sampling interval.

At ACT 704, the metering system can construct a (e.g., first) matrix based on or according to the time-series data set. The matrix can include values that indicate similarities between pairs of meters of the plurality of meters. The matrix may be referred to as or include a dependence matrix or a covariance matrix. The metering system may compute the pairwise correlation between the meters using a correlation metric (e.g., Spearman's rank correlation). In some cases, the metering system can compute the pairwise correlation between the meters by splitting the time-series data, filtering the subset of time-series data (e.g., in at least one window), using dependency measure to compute the correlations, and aggregating the correlations to generate the matrix.

At ACT 706, the metering system can generate a silhouette score for each meter in the matrix (e.g., covariance matrix) to group or partition the meters into transformer groups via the clustering techniques applied to the matrix. The silhouette score of each meter can represent the confidence that the meter is accurately grouped into the transformer group (e.g., the initial transformer group). For example, after clustering the meters into transformer groups using the clustering techniques, the metering system can generate the silhouette score for each meter according to one or more parameters, such as the distance between the meter and the transformer, the characteristics of the time-series data between the meter and one or more other meters in the (e.g., initial) transformer group, etc. The metering system can compute the silhouette score of the transformer group based on an aggregate (e.g., median) of the silhouette scores of the meter(s) within the transformer group. The metering system can regroup or shuffle the meters to different transformer groups to maximize the silhouette score for the meters or the transformer groups.

At ACT 708, the metering system can provide a digital map for output via a graphical user interface. The digital map can include an indication of at least a subset of meters of the plurality of meters associated with a transformer of the plurality of transformer groups generated based on the plurality of clustering techniques applied to the matrix. For example, the metering system can generate the graphical user interface displaying the digital map with the location of one or more meters. The metering system can provide an indication of the transformer group associated with the one or more meters. The indication can be configurable, such as color code, pattern, or value. The metering system can include other information in the graphical user interface, which may be configured by the utility operator or administrator of the system.

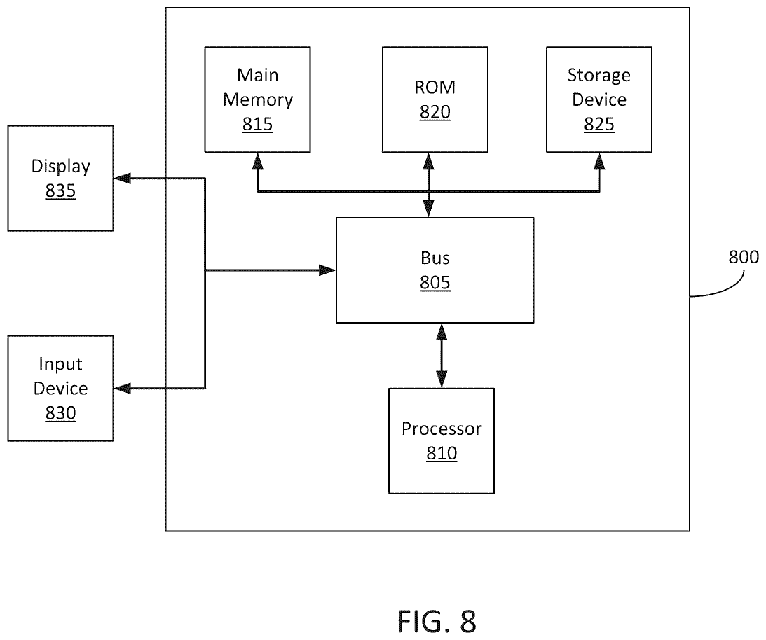

FIG. 8 is a block diagram of an example computer system 800. The computer system or computing device 800 can include or be used to implement the data processing system 150, the metering system 201, or its components. The computing system 800 includes at least one bus 805 or other communication component for communicating information and at least one processor 810 or processing circuit coupled to the bus 805 for processing information. The computing system 800 can also include one or more processors 810 or processing circuits coupled to the bus for processing information. The computing system 800 also includes at least one main memory 815, such as a random access memory (RAM) or other dynamic storage device, coupled to the bus 805 for storing information, and instructions to be executed by the processor 810. The main memory 815 can also be used for storing position information, utility grid data, command instructions, device status information, environmental information within or external to the utility grid, information on characteristics of electricity, or other information during execution of instructions by the processor 810. The computing system 800 may further include at least one read only memory (ROM) 820 or other static storage device coupled to the bus 805 for storing static information and instructions for the processor 810. A storage device 825, such as a solid state device, magnetic disk or optical disk, can be coupled to the bus 805 to persistently store information and instructions.

The computing system 800 may be coupled via the bus 805 to a display 835, such as a liquid crystal display, or active matrix display, for displaying information to a user such as an administrator of the data processing system or the utility grid. An input device 830, such as a keyboard or voice interface may be coupled to the bus 805 for communicating information and commands to the processor 810. The input device 830 can include a touch screen display 835. The input device 830 can also include a cursor control, such as a mouse, a trackball, or cursor direction keys, for communicating direction information and command selections to the processor 810 and for controlling cursor movement on the display 835. The display 835 can be part of the data processing system 150, or other components of FIGS. 1-2, among others.

The processes, systems, and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

### FURTHER EXAMPLES

The following examples pertain to further embodiments, from which numerous permutations and configurations will be apparent.

Example 1 includes a system, comprising: a data processing system comprising one or more processors, coupled with memory, to: receive a time-series data set of voltage measured by a plurality of meters at a plurality of loads in an electricity distribution grid; construct, based on the time-series data set, a matrix with values that indicate similarities between pairs of meters of the plurality of meters; generate, via a plurality of clustering techniques applied to the matrix, a silhouette score for each of the plurality of meters in the matrix to group the plurality of meters into a plurality of transformer groups; and provide, for output via a graphical user interface, a digital map with an indication of a subset of meters of the plurality of meters associated with a transformer of the plurality of transformer groups generated based on the plurality of clustering techniques applied to the matrix.

Example 2 includes the subject matter of Example 1, wherein the time-series data set comprises a second matrix having a first dimension corresponding to timestamps and a second dimension corresponding to root mean square voltage values recorded by the plurality of meters at a fixed sampling interval.

Example 3 includes the subject matter of any of Examples 1 and 2, wherein the data processing system is further configured to: generate the matrix with values that indicate the similarities using a correlation metric.

Example 4 includes the subject matter of any of Examples 1 through 3, wherein the matrix comprises a covariance matrix.

Example 5 includes the subject matter of any of Examples 1 through 4, wherein the data processing system is further configured to: generate the matrix with a Monte Carlo of combinations of at least two of: a plurality of window sizes, filters, similarity metrics, or aggregation techniques to combine correlations between the plurality of meters.

Example 6 includes the subject matter of any of Examples 1 through 5, wherein the data processing system is further configured to: generate the silhouette score for each meter via the plurality of clustering techniques with a Monte Carlo of a plurality of initial configurations of meters of the plurality of meters.

Example 7 includes the subject matter of any of Examples 1 through 6, wherein the data processing system is further configured to: execute a Monte Carlo of combinations of parameters used to generate the matrix and initial configurations used to generate the silhouette score; and determine a confidence score for a meter of the plurality of meters placed in a transformer group of the plurality of transformer groups based on a count of the combinations of the Monte Carlo of combinations that place the meter into the transformer group.

Example 8 includes the subject matter of any of Examples 1 through 7, wherein the data processing system is further configured to: apply a distance-based clustering techniques of the plurality of clustering techniques to partition the plurality of meters to generate a plurality of partitions of the plurality of meters; and generate, via the plurality of clustering techniques applied to each of the plurality of partitions, the silhouette score for each of the plurality of meters.

Example 9 includes the subject matter of any of Examples 1 through 8, wherein the data processing system is further configured to: detect that a meter is erroneously grouped into a first transformer group of the plurality of transformer groups based on a comparison of a first silhouette score of the meter and a first median silhouette score of the first transformer group; remove the meter from the first transformer group and insert the meter into a second transformer group of the plurality of transformer groups; and determine a second silhouette score of the meter inserted into the second transformer group is greater than the first silhouette score.

Example 10 includes the subject matter of any of Examples 1 through 9, wherein the plurality of clustering techniques comprise at least one of a distance-based partition, a max rand index, a maximum entropy, or a recursive binary optimization applied to the matrix, and the data processing system is further configured to: adjust a first one or more parameters used to create the matrix to determine an updated matrix; adjust a second one or more parameters of at least one of the plurality of clustering techniques to determine, based on the updated matrix, an updated silhouette score for one or more of the plurality of meters in the matrix to generate an updated subset of meters of the plurality of meters that are associated with the transformer.

Example 11 includes the subject matter of any of Examples 1 through 10, wherein the data processing system is further configured to: receive an indication of an event associated with a transformer of the plurality of transformer groups; identify, via a lookup, a second plurality of meters grouped in a transformer group of the plurality of transformer groups that correspond to the transformer associated with the event; and perform, responsive to the event, an action on the second plurality of meters, the action comprising at least one of disabling the plurality of meters, restarting the plurality of meters, or updating an application executed by the plurality of meters.

Example 12 includes a method, comprising: receiving, by a data processing system comprising one or more processors coupled with memory, a time-series data set of voltage measured by a plurality of meters at a plurality of loads in an electricity distribution grid; constructing, by the data processing system, based on the time-series data set, a matrix with values that indicate similarities between pairs of meters of the plurality of meters; generating, by the data processing system, via a plurality of clustering techniques applied to the matrix, a silhouette score for each of the plurality of meters in the matrix to group the plurality of meters into a plurality of transformer groups; and providing, by the data processing system for output via a graphical user interface, a digital map with an indication of a subset of meters of the plurality of meters associated with a transformer of the plurality of transformer groups generated based on the plurality of clustering techniques applied to the matrix.

Example 13 includes the subject matter of Example 12, wherein the time-series data set comprises a second matrix having a first dimension corresponding to timestamps and a second dimension corresponding to root mean square voltage values recorded by the plurality of meters at a fixed sampling interval.

Example 14 includes the subject matter of any of Examples 12 and 13, comprising: generating, by the data processing system, the matrix with values that indicate the similarities using a correlation metric.

Example 15 includes the subject matter of any of Examples 12 through 14, comprising: executing, by the data processing system, a Monte Carlo of combinations of parameters used to generate the matrix and initial configurations used to generate the silhouette score; and determining, by the data processing system, a confidence score for a meter of the plurality of meters placed in a transformer group of the plurality of transformer groups based on a count of the combinations of the Monte Carlo of combinations that place the meter into the transformer group.

Example 16 includes the subject matter of any of Examples 12 through 15, comprising: applying, by the data processing system, a distance-based clustering techniques of the plurality of clustering techniques to partition the plurality of meters to generate a plurality of partitions of the plurality of meters; and generating, by the data processing system, via the plurality of clustering techniques applied to each of the plurality of partitions, the silhouette score for each of the plurality of meters.

Example 17 includes the subject matter of any of Examples 12 through 16, comprising: detecting, by the data processing system, that a meter is erroneously grouped into a first transformer group of the plurality of transformer groups based on a comparison of a first silhouette score of the meter and a first median silhouette score of the first transformer group; removing, by the data processing system, the meter from the first transformer group and insert the meter into a second transformer group of the plurality of transformer groups; and determining, by the data processing system, a second silhouette score of the meter inserted into the second transformer group is greater than the first silhouette score.

Example 18 includes the subject matter of any of Examples 12 through 17, wherein the plurality of clustering techniques comprise at least one of a max rand index, a maximum entropy, or a recursive binary optimization.

Example 19 includes a non-transitory computer readable medium storing processor executable instructions that, when executed by one or more processors, cause the one or more processors to: receive a time-series data set of voltage measured by a plurality of meters at a plurality of loads in an electricity distribution grid; construct, based on the time-series data set, a matrix with values that indicate similarities between pairs of meters of the plurality of meters; generate, via a plurality of clustering techniques applied to the matrix, a silhouette score for each of the plurality of meters in the matrix to group the plurality of meters into a plurality of transformer groups; and provide, for output via a graphical user interface, a digital map with an indication of a subset of meters of the plurality of meters associated with a transformer of the plurality of transformer groups generated based on the plurality of clustering techniques applied to the matrix.

Example 20 includes the subject matter of Example 19, wherein the instructions further comprise instructions to: execute a Monte Carlo of combinations of parameters used to generate the matrix and initial configurations used to generate the silhouette score; and determine a confidence score for a meter of the plurality of meters placed in a transformer group of the plurality of transformer groups based on a count of the combinations of the Monte Carlo of combinations that place the meter into the transformer group.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
a data processing system comprising one or more processors, coupled with memory, to:
receive a time-series data set of voltage measured by a plurality of meters at a plurality of loads in an electricity distribution grid;
construct, based on the time-series data set, a matrix with values that indicate similarities between pairs of meters of the plurality of meters;
generate, via a plurality of clustering techniques applied to the matrix, a silhouette score for each of the plurality of meters in the matrix to group the plurality of meters into a plurality of transformer groups; and
provide, for output via a graphical user interface, a digital map with an indication of a subset of meters of the plurality of meters associated with a transformer of the plurality of transformer groups generated based on the plurality of clustering techniques applied to the matrix.

2. The system of claim 1, wherein the time-series data set comprises a second matrix having a first dimension corresponding to timestamps and a second dimension corresponding to root mean square voltage values recorded by the plurality of meters at a fixed sampling interval.

3. The system of claim 1, wherein the data processing system is further configured to:
generate the matrix with values that indicate the similarities using a correlation metric.

4. The system of claim 1, wherein the matrix comprises a covariance matrix.

5. The system of claim 1, wherein the data processing system is further configured to:
generate the matrix with a Monte Carlo of combinations of at least two of: a plurality of window sizes, filters, similarity metrics, or aggregation techniques to combine correlations between the plurality of meters.

6. The system of claim 1, wherein the data processing system is further configured to:
generate the silhouette score for each meter via the plurality of clustering techniques with a Monte Carlo of a plurality of initial configurations of meters of the plurality of meters.

7. The system of claim 1, wherein the data processing system is further configured to:
execute a Monte Carlo of combinations of parameters used to generate the matrix and initial configurations used to generate the silhouette score; and
determine a confidence score for a meter of the plurality of meters placed in a transformer group of the plurality of transformer groups based on a count of the combinations of the Monte Carlo of combinations that place the meter into the transformer group.

8. The system of claim 1, wherein the data processing system is further configured to:
apply a distance-based clustering techniques of the plurality of clustering techniques to partition the plurality of meters to generate a plurality of partitions of the plurality of meters; and
generate, via the plurality of clustering techniques applied to each of the plurality of partitions, the silhouette score for each of the plurality of meters.

9. The system of claim 1, wherein the data processing system is further configured to:
detect that a meter is erroneously grouped into a first transformer group of the plurality of transformer groups based on a comparison of a first silhouette score of the meter and a first median silhouette score of the first transformer group;
remove the meter from the first transformer group and insert the meter into a second transformer group of the plurality of transformer groups; and
determine a second silhouette score of the meter inserted into the second transformer group is greater than the first silhouette score.

10. The system of claim 1, wherein the plurality of clustering techniques comprise at least one of a distance-based partition, a max rand index, a maximum entropy, or a recursive binary optimization applied to the matrix, and the data processing system is further configured to:
adjust a first one or more parameters used to create the matrix to determine an updated matrix;
adjust a second one or more parameters of at least one of the plurality of clustering techniques to determine, based on the updated matrix, an updated silhouette score for one or more of the plurality of meters in the matrix to generate an updated subset of meters of the plurality of meters that are associated with the transformer.

11. The system of claim 1, wherein the data processing system is further configured to:
receive an indication of an event associated with a transformer of the plurality of transformer groups;
identify, via a lookup, a second plurality of meters grouped in a transformer group of the plurality of transformer groups that correspond to the transformer associated with the event; and
perform, responsive to the event, an action on the second plurality of meters, the action comprising at least one of disabling the plurality of meters, restarting the plurality of meters, or updating an application executed by the plurality of meters.

12. A method, comprising:
receiving, by a data processing system comprising one or more processors coupled with memory, a time-series data set of voltage measured by a plurality of meters at a plurality of loads in an electricity distribution grid;
constructing, by the data processing system, based on the time-series data set, a matrix with values that indicate similarities between pairs of meters of the plurality of meters;
generating, by the data processing system, via a plurality of clustering techniques applied to the matrix, a silhouette score for each of the plurality of meters in the matrix to group the plurality of meters into a plurality of transformer groups; and
providing, by the data processing system for output via a graphical user interface, a digital map with an indication of a subset of meters of the plurality of meters associated with a transformer of the plurality of transformer groups generated based on the plurality of clustering techniques applied to the matrix.

13. The method of claim 12, wherein the time-series data set comprises a second matrix having a first dimension corresponding to timestamps and a second dimension corresponding to root mean square voltage values recorded by the plurality of meters at a fixed sampling interval.

14. The method of claim 12, comprising:
generating, by the data processing system, the matrix with values that indicate the similarities using a correlation metric.

15. The method of claim 12, comprising:
executing, by the data processing system, a Monte Carlo of combinations of parameters used to generate the matrix and initial configurations used to generate the silhouette score; and
determining, by the data processing system, a confidence score for a meter of the plurality of meters placed in a transformer group of the plurality of transformer groups based on a count of the combinations of the Monte Carlo of combinations that place the meter into the transformer group.

16. The method of claim 12, comprising:
applying, by the data processing system, a distance-based clustering techniques of the plurality of clustering techniques to partition the plurality of meters to generate a plurality of partitions of the plurality of meters; and
generating, by the data processing system, via the plurality of clustering techniques applied to each of the plurality of partitions, the silhouette score for each of the plurality of meters.

17. The method of claim 12, comprising:
detecting, by the data processing system, that a meter is erroneously grouped into a first transformer group of the plurality of transformer groups based on a comparison of a first silhouette score of the meter and a first median silhouette score of the first transformer group;
removing, by the data processing system, the meter from the first transformer group and insert the meter into a second transformer group of the plurality of transformer groups; and
determining, by the data processing system, a second silhouette score of the meter inserted into the second transformer group is greater than the first silhouette score.

18. The method of claim 12, wherein the plurality of clustering techniques comprise at least one of a max rand index, a maximum entropy, or a recursive binary optimization.

19. A non-transitory computer readable medium storing processor executable instructions that, when executed by one or more processors, cause the one or more processors to:
receive a time-series data set of voltage measured by a plurality of meters at a plurality of loads in an electricity distribution grid;
construct, based on the time-series data set, a matrix with values that indicate similarities between pairs of meters of the plurality of meters;
generate, via a plurality of clustering techniques applied to the matrix, a silhouette score for each of the plurality of meters in the matrix to group the plurality of meters into a plurality of transformer groups; and
provide, for output via a graphical user interface, a digital map with an indication of a subset of meters of the plurality of meters associated with a transformer of the plurality of transformer groups generated based on the plurality of clustering techniques applied to the matrix.

20. The non-transitory computer-readable medium of claim 19, wherein the instructions further comprise instructions to:
execute a Monte Carlo of combinations of parameters used to generate the matrix and initial configurations used to generate the silhouette score; and
determine a confidence score for a meter of the plurality of meters placed in a transformer group of the plurality of transformer groups based on a count of the combinations of the Monte Carlo of combinations that place the meter into the transformer group.
